(19) United States
(12) Patent Application Publication
(10) Pub. No.: US 2026/0329488 A1
(43) Pub. Date: Oct. 22, 2026

(54) STORAGE MEDIUM STORING APPLICATION PROGRAM SUPPORTING GENERAL-PURPOSE PROGRAM, CONTROL METHOD, AND INFORMATION PROCESSING APPARATUS

(71) Applicant: CANON KABUSHIKI KAISHA, Tokyo (JP)

(72) Inventor: Daichi Hidaka, Tokyo (JP)

(21) Appl. No.: 19/637,075

(22) Filed: Apr. 2, 2026

(30) Foreign Application Priority Data
Apr. 22, 2025 (JP) 2025-070827

(51) Int. Cl. G06F 3/12

(52) U.S. Cl. CPC G06F 3/1205; G06F 3/1228

(57) ABSTRACT

A non-transitory computer-readable storage medium storing an application program. The application program causes a computer to execute a control method including supporting a general-purpose program operating according to the Internet Printing Protocol, displaying a setting reception screen for receiving a print setting for printing an image to be printed, after rotating the image through 180 degrees, generating print data in which the image is rotated through 180 degrees by the print setting received on the setting reception screen, and transmitting the print data to a printing apparatus.

### BACKGROUND

### Field of the Technology

The present disclosure relates to a storage medium storing an application program supporting a general-purpose program, a control method, and an information processing apparatus.

### Description of the Related Art

To a printing apparatus that performs printing, a host computer (information processing apparatus) that is capable of processing information between the same and the printing apparatus is communicably connected. As control software for controlling the printing apparatus, for example, a printer driver installed from the printing apparatus into the host computer is used. With this printer driver, it is possible to provide a print instruction from the host computer to the printing apparatus. In the host computer, an operating system (hereinafter referred to as the “OS”) as basic software is installed in advance. The printer driver is configured according to specifications defined by the OS and can operate when called from the OS. Further, the printer driver is different for each vendor that supplies a printing apparatus, i.e. a model-specific printer driver which is suitable on a printing apparatus basis.

In recent years, in Windows (registered trademark), a standard class driver (hereinafter sometimes referred to as the “standard driver”) is provided, which can be commonly used even for printing apparatuses supplied from a plurality of different vendors, respectively. Such a standard driver is incorporated in the OS in advance. Then, by connecting a desired printing apparatus to a host computer having the OS incorporating the standard driver, the standard driver can be used. This makes it possible to omit installation of a model-specific printer driver. Further, with the standard driver, a print function of the printing apparatus can be designated and used according to Print Device Capabilities (hereinafter referred to as the “PDC”) generated based on information acquired from the printing apparatus. This makes it possible to designate a print function on a printing apparatus basis by one standard driver. A function extension application (hereinafter sometimes referred to as the “extension application”) for extending a function can be associated with the standard driver. The extension application is provided from each vendor. Therefore, it is difficult to execute functions of the extension application only with the standard driver.

Japanese Laid-Open Patent Publication (Kokai) No. 2021-33526 discloses an apparatus having a first application for generating image data and a second application for causing a user to make print settings used for printing the image data. The second application is capable of setting an item which cannot be set by the first application. Examples of this item include an item for changing an image size in accordance with printing based on a predetermined standard, such as poster printing and bookbinding printing.

However, in the apparatus disclosed in Japanese Laid-Open Patent Publication (Kokai) No. 2021-33526, it is impossible to change the image size as desired by the first application, and it is impossible to change the image size as desired even by the second application.

### SUMMARY

The present disclosure is directed to providing a storage medium storing an application program supporting a general-purpose program, a control method, and an information processing apparatus.

In a first aspect of the present disclosure, there is provided a non-transitory computer-readable storage medium storing an application program, the application program causing a computer to execute a control method, the control method including supporting a general-purpose program operating according to the Internet Printing Protocol, displaying a setting reception screen for receiving a print setting for printing an image to be printed, after rotating the image through 180 degrees, generating print data in which the image is rotated through 180 degrees by the print setting received on the setting reception screen, and transmitting the print data to a printing apparatus.

In a second aspect of the present disclosure, there is provided a method of performing control to support a general-purpose program operating according to the Internet Printing Protocol, including displaying a setting reception screen for receiving a print setting for printing an image to be printed, after rotating the image through 180 degrees, generating print data in which the image is rotated through 180 degrees by the print setting received on the setting reception screen, and transmitting the print data to a printing apparatus.

In a third aspect of the present disclosure, there is provided an information processing apparatus including a general-purpose program operating according to the Internet Printing Protocol and an application program supporting the general-purpose program, wherein the application program causes a computer of the information processing apparatus to display a setting reception screen for receiving a print setting for printing an image to be printed, after rotating the image through 180 degrees, generate print data in which the image is rotated through 180 degrees by the print setting received on the setting reception screen, and transmit the print data to a printing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system according to a first embodiment.

FIGS. 2A-A and 2A-B are block diagrams each showing a software configuration of the printing system.

FIGS. 2B-A to 2B-D are diagrams showing the outline of execution of a scaling function.

FIGS. 3A to 3D are diagrams each showing an example of a screen displayed on a display section of the printing system.

FIG. 4 is a flowchart of a process performed by a print function-extending unit for editing print function information.

FIG. 5 is a diagram showing an example of a list of capabilities information of a printing apparatus.

FIG. 6 is a diagram showing an example of a list of print functions supported by an extension application.

FIG. 7 is a diagram showing an example of a list of capabilities information of general-purpose print software.

FIG. 8 is a sequence diagram showing a process executed between a drawing application, the general-purpose print software, the extension application, and the printing apparatus, after the drawing application receives print settings.

FIG. 9 is a block diagram showing a software configuration of a printing system according to a second embodiment.

FIG. 10 is a flowchart of a process performed by the print function-extending unit for editing print function information.

FIG. 11 is a diagram showing an example of a list of the capabilities information of the printing apparatus.

FIG. 12 is a sequence diagram showing a process executed between the drawing application, the general-purpose print software, the extension application, and the printing apparatus, after the drawing application receives print settings.

FIGS. 13A to 13C are diagrams each showing an example of a screen displayed on the display section of the printing system according to a third embodiment.

FIGS. 14A to 14C are diagrams each showing an example of a screen displayed on the display section of the printing system according to a fourth embodiment.

FIGS. 15A and 15B are diagrams each showing an example of a printing position of print data on a print sheet.

FIGS. 16A and 16B are diagrams each showing an example of a screen displayed on the display section of the printing system according to a fifth embodiment.

FIG. 17 is a diagram showing an example of a list of the capabilities information of the printing apparatus according to a sixth embodiment.

FIGS. 18A to 18E are diagrams each showing an example of a screen displayed on the display section of the printing system.

FIG. 19 is a flowchart of a process (process for adding print setting instruction information to print data) performed by an intermediate data-editing unit.

FIG. 20 is a diagram showing an example of a screen displayed on the display section of the printing system according to a seventh embodiment.

FIG. 21 is a diagram showing an example of a list of the capabilities information of the printing apparatus according to an eighth embodiment.

FIGS. 22A to 22C are diagrams each showing an example of a screen displayed on the display section of the printing system.

FIG. 23 is a flowchart of a process (layout process) performed by the intermediate data-editing unit.

FIGS. 24A and 24B are diagrams each showing an example of the layout of pages in a case where the layout process is performed by the intermediate data-editing unit.

FIG. 25 is a diagram showing an example of a print result obtained in a case where the layout process is performed by the intermediate data-editing unit.

FIG. 26 is a diagram showing an example of a print result obtained in a case where the layout process is performed by the printing apparatus.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configuration of the present disclosure can be replaced with desired components which can exhibit the same functions. Further, desired components can be added. Further, two or more desired components (features) of the embodiments can be combined.

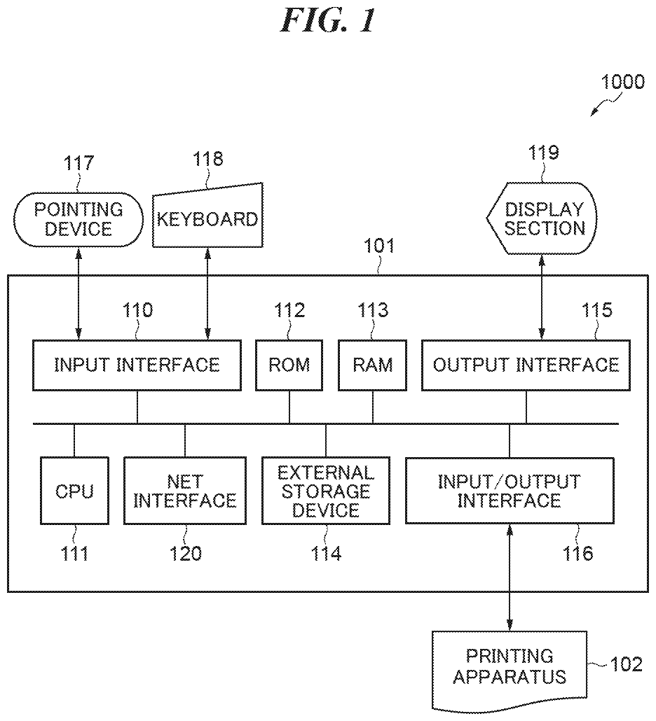

A first embodiment will be described below with reference to FIGS. 1 to 8.

FIG. 1 is a block diagram showing a hardware configuration of a printing system according to the first embodiment. As shown in FIG. 1, the printing system, denoted by reference numeral 1000, includes a host computer 101, a printing apparatus 102, a pointing device 117, a keyboard 118, and a display section 119, and these are communicably connected to each other. The host computer 101 is an information processing apparatus and includes an input interface 110, a CPU 111, a ROM 112, a RAM 113, an external storage device (storage medium) 114, an output interface 115, an input/output interface 116, and a NET interface 120. Note that although, as the host computer 101, for example, a desktop-type personal computer can be used, this is not limitative, but, for example, any of a laptop-type personal computer, a tablet terminal, and a smartphone can be used.

The CPU 111 is a computer that executes e.g. programs stored in the ROM 112 or the external storage device 114. In the ROM 112, an initialization program is stored. In the external storage device 114, an application program group, an OS, print data generation software, and a variety of other data items are stored. Note that in the present embodiment, as the OS, Windows (registered trademark) 11 of Microsoft (registered trademark) has been installed in the host computer 101. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a print setting screen 300A and a detailed setting screen 300C, described hereinafter, are displayed. The NET interface 120 is a network interface and performs control to transfer data to and from an external apparatus via a network. To the input/output interface 116, the printing apparatus 102 is connected. This enables the host computer 101 to communicate with the printing apparatuses 102 of a plurality of makers, i.e. process information between the host computer 101 and the printing apparatuses 102 of the plurality of makers, regardless of the maker of the printing apparatus 102.

As the printing apparatus 102, for example, a multi-function peripheral (MFP) having a plurality of functions, such as copy, print, and FAX functions, can be used, but this is not limitative. Further, printing performed by the printing apparatus 102 is printing by an electrophotographic method in the present embodiment but is not limited to this, and for example, printing by an inkjet method or the like can be performed. Further, although in the present embodiment, the host computer 101 and the printing apparatus 102 are configured as the apparatuses separate from each other, this is not limitative. For example, the host computer 101 and the printing apparatus 102 can be configured as an integrated apparatus.

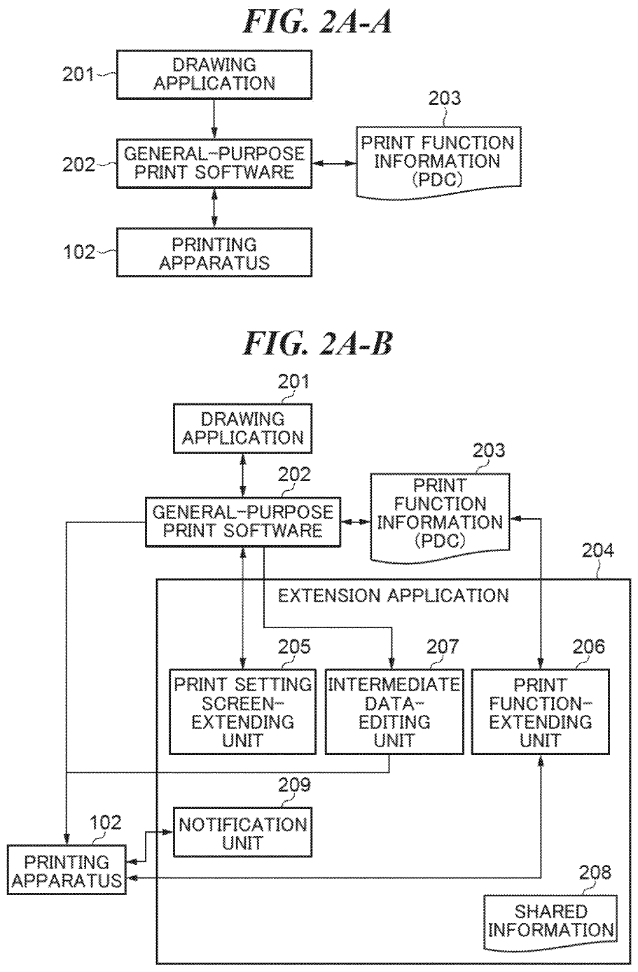

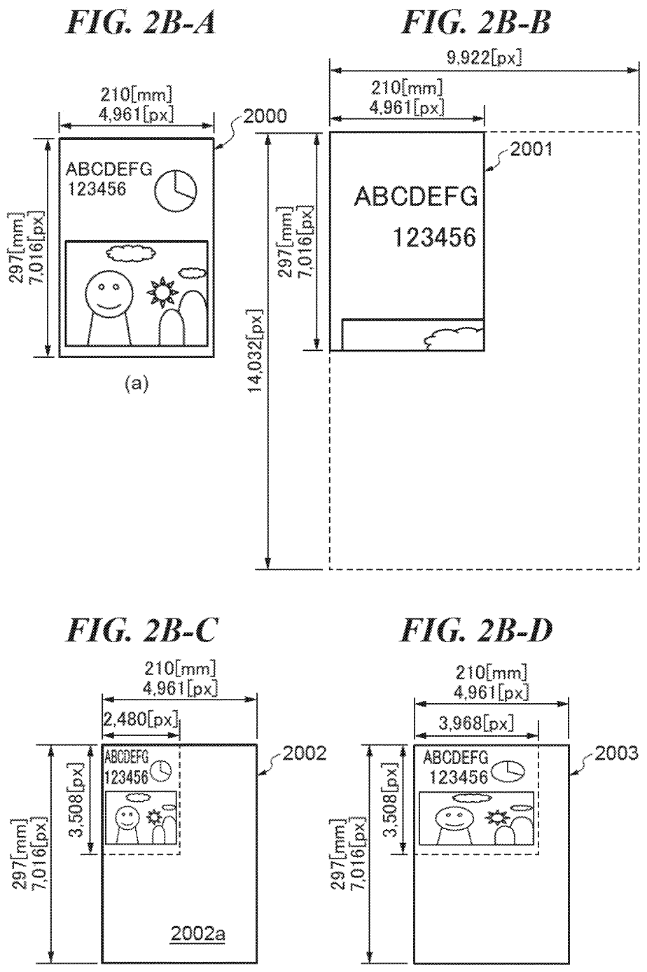

FIGS. 2A-A and 2A-B are block diagrams each showing a software configuration of the printing system 1000. FIG. 2A-A is a diagram showing a general configuration in a case where an extension application (application program) 204 is not associated with general-purpose print software (general-purpose program) 202 and the printing apparatus 102. FIG. 2A-B is a diagram showing a configuration in a case where the extension application 204 is associated with the general-purpose print software 202 and the printing apparatus 102. The general-purpose print software 202 is a program that generates data which can be printed by the printing apparatuses 102 of a plurality of makers, i.e. which can be commonly used for the printing apparatuses 102 of a plurality of makers when printing is performed, and is installed in the OS in advance. The general-purpose print software 202 is capable of transmitting print data generated by the general-purpose print software 202 to the printing apparatus 102. As the general-purpose print software 202, a program operating based on the Internet Printing Protocol (IPP) is used. The extension application 204 is a program supporting i.e. assisting the general-purpose print software 202. In the present embodiment, the extension application 204 is an extension program (program for executing a control method) capable of extending functions which cannot be executed by the general-purpose print software 202, such that the functions can be extended, for the printing apparatus 102, but is not limited to this. For example, the extension application 204 can be a program which improves the convenience of functions which can be executed by the general-purpose print software 202 for the printing apparatus 102. The extension application 204 is stored in the external storage device 114 together with the OS (the general-purpose print software 202), for example. With this, the host computer 101 has the general-purpose print software 202 and the extension application 204.

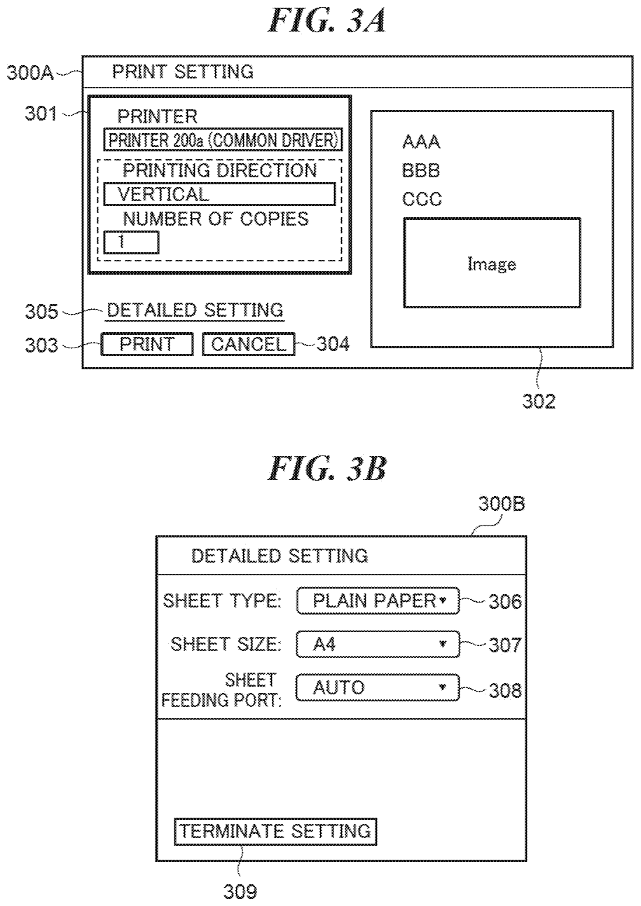

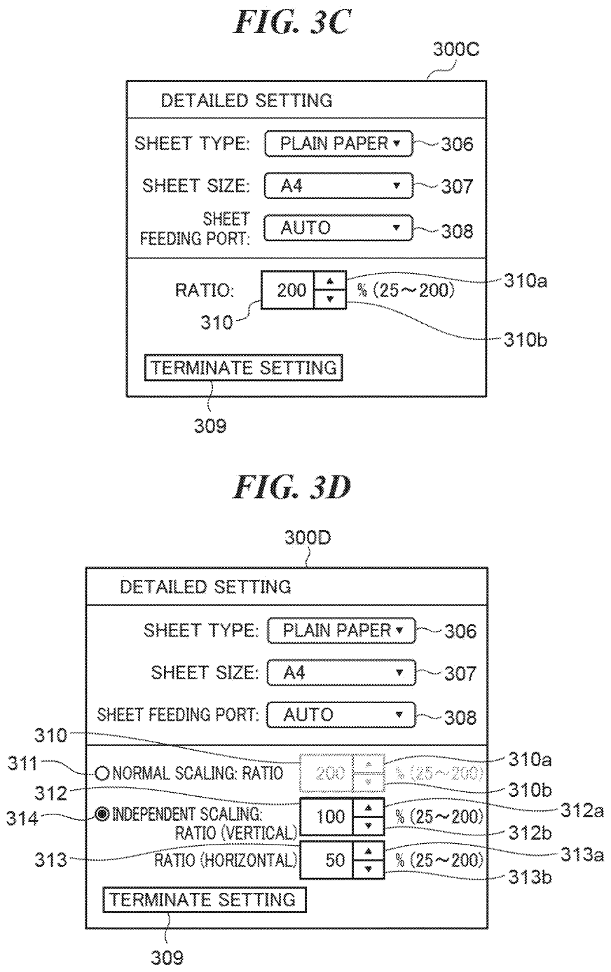

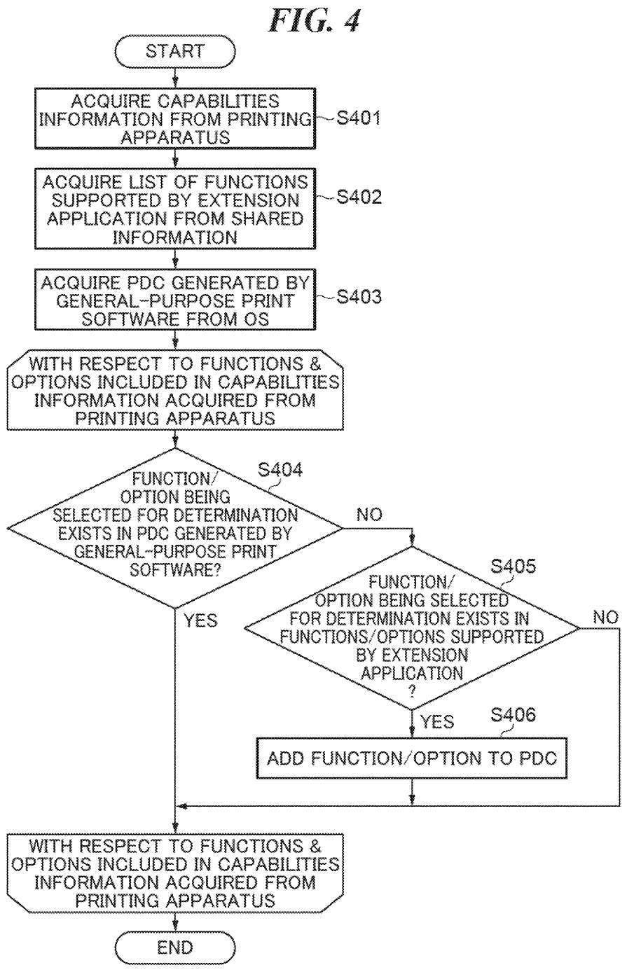

First, referring to FIG. 2A-A, the configuration in the case where the extension application 204 is neither associated with general-purpose print software 202 nor with the printing apparatus 102 will be described first. A drawing application 201 is software for generating contents (print data) to be printed by the printing apparatus 102. The drawing application 201 is not particularly limited, but, for example, a document generation application, a spreadsheet application or the like can be the drawing application 201. The drawing application 201 issues a print instruction to the OS e.g. upon receipt of a print request from a user e.g. via the keyboard 118. The print instruction includes print setting information for instructing operations of the general-purpose print software 202 and the printing apparatus 102. The print setting information is also referred to as the “Print Ticket (PT)”. Further, to output the print setting information, the drawing application 201 can display the print setting screen 300A (see FIG. 3A) provided by one of the general-purpose print software 202, the OS, and the drawing application 201, on the display section 119. Further, when a control 305 in the print setting screen 300A is operated (pressed), the drawing application 201 can display a detailed setting screen 300B (see FIG. 3B) or the detailed setting screen 300C (see FIG. 3C) on the display section 119. The print setting screens 300A to 300C will be described hereinafter. The print setting screen 300A includes a setting item indicating a print function which can be set according to capabilities information acquired by the general-purpose print software 202, i.e. information which can be set as the print setting, and a control item indicating its setting (value). The capabilities information refers to information related to the capabilities of the printing apparatus 102 for performing printing and is also referred to as the Print Capabilities (hereinafter sometimes referred to as the “PC”). Further, it is also possible to determine whether or not with this capabilities information includes information which enables the display of the detailed setting screen 300C. Then, if a result of the determination shows that the information which enables the display of the detailed setting screen 300C is included, the detailed setting screen 300C can be caused to be displayed. On the other hand, if the result of the determination shows that the information which enables the display of the detailed setting screen 300C is not included, the display of the detailed setting screen 300C is inhibited.

The general-purpose print software 202 determines a PC based on print function information 203. The print function information 203 is data indicating all print functions which can be set, settings of these print functions, and a print function describing an exclusive relationship between settings and the like. The print function information 203 is also referred to as the Print Device Capabilities (PDC). The print function information 203 is included in a configuration file of the general-purpose print software 202 and is disposed in the external storage device 114 as an unchangeable file. Alternatively, the print function information 203 is dynamically generated by the general-purpose print software 202. Specifically, the general-purpose print software 202 acquires attribute data of the printing apparatus 102 from the printing apparatus 102. The general-purpose print software 202 generates the print function information 203 according to attribute information in the attribute data. Note that in a case where the print function information 203 is dynamically generated as described above, the print function information 203 can be edited. Further, the attribute data of the printing apparatus 102 refers to a response acquired by issuing a “Get-Printer-Attributes” operation of the IPP to the printing apparatus 102. The response includes the attribute information indicating the functions which can be designated in the printing apparatus 102, i.e. capabilities of the printing apparatus 102 and settings related to the attribute information. Further, the response is stored in the RAM 113.

With the configuration described above, the general-purpose print software 202 enables a user to designate a print function which can be used in the printing apparatus 102, according to the printing apparatus 102 connected to the general-purpose print software 202. With this, regardless of the printing apparatus 102 connected to the general-purpose print software 202, i.e. even in a case where the printing apparatus 102 having a different function or the printing apparatus 102 developed by a different printer maker is connected, it is possible to designate a print function which can be used in the connected printing apparatus 102. Note that in the present embodiment, it is assumed that the general-purpose print software 202 is configured to use the IPP Class Driver installed in Windows (registered trademark) 11. The IPP Class Driver is a printer driver that executes print processing according to specifications of a standard print protocol referred to as the IPP, and is incorporated in the OS package. The IPP Class Driver is not a printer driver specific to a model of the printing apparatus 102 but is a standard class driver which can be commonly used for printing apparatuses 102 of printer makers, without depending on a specific printer maker. Further, the IPP Class Driver acquires the capabilities information of the printing apparatus 102 and generates the print function information 203 based on the acquired information.

Further, the general-purpose print software 202 can be associated with the extension application 204. This enables the general-purpose print software 202 to execute a function which is not supported by the general-purpose print software 202. For example, the IPP Class Driver (the general-purpose print software 202) cannot execute a function of receiving a numerical value of a printing scaling which is set when print data is printed in an enlarged or reduced state by the printing apparatus 102, i.e. a scaling ratio which is set when the print data is printed by scaling the image data. The function of receiving a numerical value of a scaling ratio is hereinafter referred to as the “scaling function” or “scaling processing”. As mentioned above, the IPP Class Driver does not support execution of the scaling function for the printing apparatus 102. This is because the scaling function is a function uniquely executed by the printing apparatus 102 manufactured by a predetermined printer maker. The extension application 204 can extend the scaling function which cannot be executed by the IPP Class Driver such that the scaling function can be executed. Although in the present embodiment, the IPP Class Driver cannot execute the scaling function, and the extension application 204 can extend the scaling function such that the scaling function can be executed, this is not limitative. For example, the IPP Class Driver can execute part of the scaling function, and the extension application 204 can further extend the execution range by compensating for the shortage of the scaling function.

As described above, the scaling function is a function of receiving a numerical value of a scaling ratio which is set when the print data is printed by the printing apparatus 102 by scaling the print data. Examples of use of the scaling function include a case where a user desires to enlarge only part of an original and print the part on the whole print sheet, and a case where a user desires to provide wide margins in a print sheet by reducing an original. The scaling ratio can be expressed by the following equation (1):

$$The scaling ratio ( \% ) = \frac{size of image in vertical direction after scaling}{size of image in vertical direction before scaling} \times 100 \qquad ( 1 )$$

As is clear from this equation (1), the scaling ratio refers to an enlargement or reduction ratio of an image in the vertical direction before and after executing the scaling function. In this case, an aspect ratio set when an image is enlarged or reduced is fixed. Note that a case where the aspect ratio is changed will be described hereinafter. For example, when desired to enlarge the sizes of an image two times in the vertical direction and the horizontal direction, respectively, it is only required to set a value of 200% as the scaling ratio. Note that although the scaling ratio mentioned here is the enlargement or reduction ratio of an image in the vertical direction before and after executing the scaling function, this is not limitative. For example, the scaling ratio can be set to an enlargement or reduction ratio of an image in the horizontal direction before and after executing the scaling function, or can be set to an enlargement or reduction ratio of an area of an image before and after executing the scaling function.

As execution example 1 of the scaling function, a description will be given of the scaling function for enlarging or reducing the vertical and horizontal sizes of print data, which has been converted to raster data, based on a numerical value of the scaling ratio and printing the enlarged or reduced print data on a print sheet. First, the vertical and horizontal sizes [px] of the print data after being subjected to the scaling processing based on the scaling ratio are calculated. Then, the enlargement/reduction processing is executed by using an enlargement/reduction algorithm, described hereinafter, such that the print data is converted to the calculated sizes [px]. Then, this processed print data is printed on a print sheet. Note that here, although the case where the enlargement/reduction processing is executed on the raster image data is described by way of example, this is not limitative. For example, the enlarged/reduced raster image data can be acquired by executing the enlargement/reduction processing on vector image data, and then executing rendering processing. Thus, the scaling function in the present embodiment is only required to be a function that makes it possible to print the print data enlarged or reduced at the scaling ratio on a print sheet. Note that the enlargement/reduction algorithm is not particularly limited, but for example, it is only required to be an algorithm that is capable of enlarging or reducing both of the vertical and horizontal sizes [px] of print data before being subjected to the scaling processing to desired sizes [px]. Examples of this algorithm include the bicubic method, the nearest-neighbor method, and the bilinear method. Further, as another enlargement/reduction algorithm, for example, there is an algorithm which becomes higher in accuracy in one of enlargement and reduction. Further, enlargement/reduction algorithms which are different from each other can be used for enlargement and reduction, respectively.

FIGS. 2B-A to 2B-D are diagrams showing the outline of execution of a scaling function. As shown in FIG. 2B-A, a print sheet 2000 has a sheet size of A4. On this print sheet 2000, the size of print data in the vertical direction before execution of the scaling function is 7016 [px], and the size in the horizontal size is 4961 [px]. A description will be given of a case where the scaling function is executed under such a condition. It is assumed that the scaling ratio in this scaling function is set to 200% for the enlarged printing, and to 50% for the reduced printing. The size [px] of the print data in the vertical direction after execution of the scaling function can be expressed by the following equation (2). Further, the size [px] of the print data in the horizontal direction after execution of the scaling function can be expressed by the following equation (3):

The size [px] of the print data in the vertical direction after execution of the scaling function

$$= the size [ px ] of the print data in the vertical direction before execution of the scaling function \times \frac{scaling ratio [ \% ]}{100} \qquad ( 2 )$$

The size [px] of the print data in the horizontal direction after execution of the scaling function

$$= the size [ px ] of the print data in the horizontal direction before execution of the scaling function \times \frac{scaling ratio [ \% ]}{100} \qquad ( 3 )$$

As described above, the scaling ratio refers to an enlargement ratio or a reduction ratio of an image in the vertical direction before and after execution of the scaling function, and further, the aspect ratio set when an image is enlarged or reduced is fixed. In the case where the scaling ratio is 200%, the size in the vertical direction is obtained as 14032 [px]=7016 [px]×200 [%]/100 by using the equation (2), and the size in the horizontal direction is obtained as 9922 [px]=4961 [px]×200 [%]/100 by using the equation (3). Then, the enlargement processing is executed on the print data according to the size in the vertical direction, obtained by the equation (2), and the size in the horizontal direction, obtained by the equation (3), by using the enlargement/reduction algorithm. Then, as shown in FIG. 2B-B, the print data after being subjected to the enlargement processing is printed on the print sheet. In such printing, an upper left corner of the print data after being subjected to the enlargement processing is arranged to be positioned at an upper left corner of a print sheet 2001. Therefore, the enlarged print data is larger in size than the A4-size print sheet 2001 (7016 [px]×4961 [px]), and hence only an image area within the print sheet 2001 is printed on the print sheet 2001.

In the case where the scaling ratio is 50%, the size in the vertical direction is obtained as 3508 [px]=7016 [px]×50 [%]/100 by using the equation (2), and the size in the horizontal direction is obtained as 2480 [px]=4961 [px]×50 [%]/100 by using the equation (3). Then, the reduction processing is executed on the print data according to the size in the vertical direction, obtained by the equation (2), and the size in the horizontal direction, obtained by the equation (3), by using the enlargement/reduction algorithm. Then, as shown in FIG. 2B-C, the print data after being subjected to the reduction processing is printed on a print sheet 2002. In such printing, an upper left corner of the print data after being subjected to the reduction processing is arranged to be positioned at an upper left corner of the print sheet 2002. Therefore, the reduced print data is smaller in size than the A4-size print sheet 2002, and hence a margin 2002a is produced in the lower right part of the print sheet 2002.

As execution example 2 of the scaling function will be given of an independent scaling function for changing the aspect ratio of print data by executing the scaling processing. In the independent scaling function, differently from execution example 1 of the scaling function, the scaling ratio [%] in the vertical direction and the scaling ratio [%] in the horizontal direction can be set independently from each other. Here, a case where the scaling ratio in the vertical direction is set to 50 [%], and the scaling ratio in the horizontal direction is set to 80 [%] will be described. The size [px] of print data in the vertical direction after execution of the scaling function can be expressed by the following equation (4). Further, the size [px] of the print data in the horizontal direction after execution of the scaling function can be expressed by the following equation (5):

The size [px] of the print data in the vertical direction after execution of the scaling function

$$= the size [ px ] of the print data in the vertical direction before execution of the scaling function \times \frac{scaling ratio ( vertical ) [ \% ]}{100} \qquad ( 4 )$$

The size [px] of the print data in the horizontal direction after execution of the scaling function

$$= the size [ px ] of the print data in the horizontal direction before execution of the scaling function \times \frac{scaling ratio ( lateral ) [ \% ]}{100} \qquad ( 5 )$$

In the case where the scaling ratio in the vertical direction is 50 [%], the size in the vertical direction is obtained as 3508 [px]=7016 [px]×50 [%]/100 by using the equation (4). In the case where the scaling ratio in the horizontal direction is 80 [%], the size in the horizontal direction is obtained as 3968 [px]=4961 [px]×80 [%]/100 by using the equation (5). Then, the scaling processing is executed on the print data according to the size in the vertical direction, obtained by the equation (4), and the size in the horizontal direction, obtained by the equation (5), by using the enlargement/reduction algorithm. Then, as shown in FIG. 2B-D, the print data after being subjected to the reduction processing is printed on a print sheet 2003. In this printing, since the scaling ratio (80%) in the horizontal direction is larger than the scaling ratio (50%) in the vertical direction, the print data after being subject to the scaling processing is printed as an image extended in the horizontal direction of the print sheet 2003. Note that although in this example, when the independent scaling function is executed, the scaling ratio in the vertical direction and the scaling ratio in the horizontal direction are set to values smaller than 100 [%], i.e., values suitable for reduced printing, respectively, this is not limitative. For example, the scaling ratio in the vertical direction and the scaling ratio in the horizontal direction can be set to values larger than 100 [%], i.e., values suitable for enlarged printing, respectively, or one of the scaling ratio in the vertical direction and the scaling ratio in the horizontal direction can be set to a value smaller than 100 [%], and the other of them can be set to a value larger than 100 [%].

Here, the description refers again to FIG. 2A-A. The OS generates intermediate data (sometimes referred to as the “input data”) based on a print instruction output from the drawing application 201 and transmits the generated intermediate data to the general-purpose print software 202. The data to be output for printing from the drawing application 201 is not particularly limited, but, for example, data of the XML Paper Specification format (XPS format) is preferable. Further, as the data to be output for printing from the drawing application 201, data of the Graphic Device Interface format (GDI format) can be used. In a case where the IPP Class Driver is used as the general-purpose print software 202, if data output from the drawing application 201 is GDI data, the OS converts the GDI data to XPS data. Then, the OS transmits the converted XPS data to the general-purpose print software 202 as the intermediate data. Further, if data output from the drawing application 201 is XPS data, the OS transmits the XPS data to the general-purpose print software 202 as the intermediate data. Note that the intermediate data includes drawing data as information on characters, figures, and the like, which are to be formed on a printing medium, and the print setting information set by the user.

The general-purpose print software 202 converts the intermediate data to print data (image data) which can be processed, i.e. can be printed by the printing apparatus 102 and transmits the converted data to the printing apparatus 102. Here, the print data in the present embodiment is page description language (PDL) data conforming to the IPP. The PDL data is, for example, data of the portable document format (PDF) or of the PWG-Raster format. Note that the print data includes drawing data as information on e.g. characters, figures, and the like, which are to be formed on a print sheet (printing medium), and print setting attribute information designating print settings, which is generated based on the print setting information set by the user. The print setting attribute information includes attribute information indicating functions which can be designated in the printing apparatus 102, i.e. the capabilities of the printing apparatus 102, and settings related to the attribute information.

The printing apparatus 102 performs printing on a print sheet based on the print data transmitted from the general-purpose print software 202. In doing this, the printing apparatus 102 can form an image on the print sheet based on the drawing data included in the print data, by performing operations according to the print setting attribute information included in the print data. Note that the print setting attribute information includes, for example, attribute information for designating a print quality setting, such as image quality priority or speed priority, double-side printing or single-sided printing, and so forth, and settings of the attribute information. For example, in a case where attribute information designating double-sided printing is included in the print setting attribute information, the printing apparatus 102 can execute double-sided printing.

Referring to FIG. 2A-B, the configuration in the case where the extension application 204 is associated with the general-purpose print software 202 and the printing apparatus 102 will be described. As shown in FIG. 2A-B, differently from FIG. 2A-A, the extension application 204 is additionally provided. That is, the host computer 101 includes the drawing application 201, the general-purpose print software 202, and the print function information 203, and further has the extension application 204. The extension application 204 is software for extending the functions of the general-purpose print software 202. Note that the extension application 204 is software not included (packaged) in the OS in advance. Therefore, the extension application 204 is downloaded from a server (not shown) via the Internet and installed into the host computer 101 according to a user's operation of the host computer 101. Alternatively, when the printing apparatus 102 is connected to the host computer 101, the extension application 204 can be automatically installed into the host computer 101 according to this connection. Specifically, in a case where the printing apparatus 102 is connected to the host computer 101, the OS acquires device identification information from the printing apparatus 102. The OS can download the extension application 204 associated with this device identification information from the server via the Internet and install the downloaded extension application 204. As a result, in the host computer 101, the general-purpose print software 202 and the extension application 204 are held as control programs different from each other. Note that the general-purpose print software 202 and the extension application 204 are sometimes updated and their versions are upgraded, respectively. The processing for updating the general-purpose print software 202 and the processing for updating the extension application 204 in this case are performed at the same timing or at different timings. Further, a trigger with which the general-purpose print software 202 is acquired by the host computer 101 and a trigger with which the extension application 204 is acquired by the host computer 101 can be the same trigger or different triggers. Further, in a case where the extension application 204 has been installed, the OS associates the extension application 204 with the general-purpose print software 202 and the printing apparatus 102.

As shown in FIG. 2A-B, the extension application 204 is capable of exchanging information (transmission and reception of information) with the general-purpose print software 202 and the printing apparatus 102, respectively. That is, the extension application 204 is associated with the general-purpose print software 202 and the printing apparatus 102. In the present embodiment, the extension application 204 includes a print setting screen-extending unit 205, a print function-extending unit 206, an intermediate data-editing unit 207, and a notification unit 209. Further, the extension application 204 includes shared information 208 which can be accessed from each of the print setting screen-extending unit 205, the print function-extending unit 206, the intermediate data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the whole operation of the extension application 204 in accordance with termination of processing executed by each of the print setting screen-extending unit 205 to the notification unit 209. In this case, the OS starts the extension application 204 whenever a request for causing each unit to execute processing is received. Further, the OS terminates the whole operation of the extension application 204 in a case where processing executed e.g. by the print setting screen-extending unit 205 is terminated. Further, while the processing is being performed by each of the print setting screen-extending unit 205 to the notification unit 209, the extension application 204 can cancel this processing. In this case, a job being processed on a print queue is deleted by the OS. As described above, upon receipt of a print request from a user, the drawing application 201 issues a print instruction to the OS. Further, the drawing application 201 can display the print setting screen. In the configuration shown in FIG. 2A-B, the drawing application 201 can display the print setting screen 300A (detailed setting screen 300C) provided by the print setting screen-extending unit 205 (the extension application 204). Further, the print setting screen-extending unit 205 can store detailed settings made by the user in the shared information 208. Details of the print setting screen-extending unit 205 will be described hereinafter.

The intermediate data-editing unit 207 acquires intermediate data from the general-purpose print software 202. Then, the intermediate data-editing unit 207 converts the intermediate data to print data and then transmits the print data to the printing apparatus 102. Further, the intermediate data-editing unit 207 acquires detailed setting information from the shared information 208 and adds the detailed settings to the print data. The printing apparatus 102 performs printing on a sheet surface based on the print data received from the intermediate data-editing unit 207. Note that the extension application 204 can be configured to acquire print data generated by the general-purpose print software 202 and add the detailed settings to the print data. Further, also in the case of the configuration shown in FIG. 2A-B, there is a case where the scaling function is not executed. In this case, the general-purpose print software 202 can transmit print data to the printing apparatus 102 without using the extension application 204.

The print function-extending unit 206 can edit the print function information 203 (PDC) generated by the general-purpose print software 202 or the OS. This makes it possible to add a function provided by the extension application 204. Further, it is also possible to add a function, e.g. the scaling function, which can be executed in the printing apparatus 102 but cannot be executed by the general-purpose print software 202, and add an exclusive relationship between settings of the print function. The OS starts the print function-extending unit 206 when the extension application 204 is associated with the printing apparatus 102 and the general-purpose print software 202 for the first time. Further, the OS can start the print function-extending unit 206 at a timing other than this (e.g. at a timing when the OS is started). By starting the print function-extending unit 206 as described above, even in a case where a function related to printing is extended later, the print function-extending unit 206 can detect the extended function and add the detected function to the print function information 203. Examples of the case where the function related to printing is extended later include a case where an optional apparatus (such as a finisher) is added to the printing apparatus 102 afterwards.

The notification unit 209 can provide, when an error of the printing apparatus 102 occurs, a notification indicating this fact. For example, if a paper-out error has occurred in the printing apparatus 102, the general-purpose print software 202 detects occurrence of this error. The OS displays a message showing occurrence of the paper-out error as a result of the detection performed by the general-purpose print software 202 on the display section 119 by using a notification function called a toast notification which is one of the functions of the OS. Upon execution of the toast notification by the user, the notification unit 209 is called by the OS, and a user interface screen (UI screen) of the notification unit 209 is displayed. On the user interface screen, for example, a detailed message concerning the paper-out error, a paper filling method, and so forth can be displayed.

As described above, in the present embodiment, it can be said that the extension application 204 has the following four functions: The first function is the function of displaying a setting screen. This function is executed by the print setting screen-extending unit 205. The second function is the function of editing intermediate data, converting the intermediate data to print data, and adding detailed settings to the print data. This function is executed by the intermediate data-editing unit 207. The third function is the function of extending a function which can be designated by using print data generation software. This function is executed by the print function-extending unit 206. The fourth function is the function of displaying a screen in response to occurrence of an error in the printing apparatus 102. This function is executed by the notification unit 209. Note that the configuration of the extension application 204 is not limited to the configuration having these four functions but preferably includes at least one function of them, and further, the extension application 204 can be configured to have still another function. Further, when print data is once transmitted to the printing apparatus 102, the extension application 204 cannot display a screen, such as a guide associated with the print data, during execution of processing performed by each unit.

FIGS. 3A to 3D are diagrams each showing an example of a screen displayed on the display section of the printing system 1000. FIG. 3A shows the print setting screen displayed by the drawing application 201. FIG. 3B shows the detailed setting screen displayed in the case of the configuration in which the extension application 204 is not associated. FIGS. 3C and 3D each show the detailed setting screen displayed in the case of the configuration in which the extension application 204 is associated. Note that a unit or module that displays each screen is not particularly limited. For example, the print setting screen-extending unit 205 can be configured to generate only a display screen. In this case, the print setting screen-extending unit 205 transmits the generated display screen to the drawing application 201 via the general-purpose print software 202. The drawing application 201 can be configured to display the acquired display screen.

The print setting screen 300A shown in FIG. 3A is a screen on which print conditions for printing performed by the printing apparatus 102 can be set. This print setting screen 300A includes a control 301, a control 302, a control 303, a control 304, and the control 305. With the control 301, the user can set the printing apparatus 102 used for printing, a direction of printing performed by the printing apparatus 102, and the number of copies to be printed by the printing apparatus 102. In the illustrated example in FIG. 3A, the printing apparatus 102 used for printing is set to “printer 200a”, the direction of printing performed by the printing apparatus 102 is set to “vertical”, and the number of copies to be printed by the printing apparatus 102 is set to “1”, by way of example. The control 302 displays a preview screen. With the control 303, the user can instruct the printing apparatus 102 to start printing. With the control 304, the user can instruct the printing apparatus 102 to cancel printing. With the control 305, the user can make detailed settings.

When the control 305 is operated in the case of the configuration in which the extension application 204 is not associated, the detailed setting screen 300B shown in FIG. 3B is displayed. The detailed setting screen 300B includes a control 306, a control 307, a control 308, and a control 309. The controls 306 to 308 are arranged vertically in an upper part of the detailed setting screen 300B. The control 309 is arranged in a lower part of the detailed setting screen 300B. With the control 306, the user can select and set a type of sheets to be used for printing performed by the printing apparatus 102. In the illustrated example in FIG. 3B, “plain paper” is selected by way of example. With the control 307, the user can select and set a size of sheets to be used for printing performed by the printing apparatus 102. In the illustrated example in FIG. 3B, “A4” is selected by way of example. With the control 308, the user can select a sheet feeding port to be used for printing performed by the printing apparatus 102. In the illustrated example in FIG. 3B, “auto” has been selected, by way of example. With the control 309, the user can terminate making settings with the controls 306 to 308. Further, when the control 309 is operated, the screen returns to the print setting screen 300A shown in FIG. 3A.

When the control 305 is operated in the case of the configuration in which the extension application 204 is associated, the detailed setting screen (setting reception screen) 300C shown in FIG. 3C or a detailed setting screen 300D shown in FIG. 3D is displayed. First, the detailed setting screen 300C will be described. The detailed setting screen 300C is a screen displayed together with the print setting screen 300A, but its display form is not particularly limited. For example, the detailed setting screen 300C can be displayed in a state overlapping the print setting screen 300A, or can be displayed adjacent to the print setting screen 300A, or can be displayed after the print setting screen 300A once disappears. The detailed setting screen 300C is a screen which can receive a numerical value of a scaling ratio, which is set when print data is printed by the printing apparatus 102 after being subjected to scaling. Similar to the detailed setting screen 300B, the detailed setting screen 300C includes the controls 306 to 309. Further, the detailed setting screen 300C additionally includes a control 310.

The control 310 is an input section for inputting a numerical value of a scaling ratio. In the control 310, an up button 310a for ascending, i.e., increasing the value in the control 310 and a down button 310b for descending, i.e., reducing the value are vertically arranged side by side. Then, by appropriately pressing the up button 310a or the down button 310b, the user can change the value in the control 310 by 1 [%] with each operation, thereby setting the value to a desired magnitude. In the illustrated example in FIG. 3C, 200% is set by way of example. Note that the changing width of the numerical value, which can be changed by one operation of pressing the up button 310a or the down button 310b, is not limited to 1 [%], but, for example, the changing width can be e.g. 0.1 [%]. Further, in the control 310, a range of the numerical value which can be input to the control 310 is specified. With this, the user can input a numerical value in a range in which the scaling function can be executed. Although in FIG. 3C, the numerical value range is specified to “25% to 200%” by way of example, but is not limited to this. Note that in the configurations shown in FIGS. 3C and 3D, although the control 310 is disposed below the control 308, this is not limitative.

Next, the detailed setting screen 300D will be described, but the description will be given mainly of different points from the detailed setting screen 300C, and description of the same points is omitted. The detailed setting screen 300D is a screen supporting execution of the independent scaling function. Similar to the detailed setting screen 300C, the detailed setting screen 300D includes the controls 306 to 310. Further, the detailed setting screen 300D additionally includes a control 311, a control 312 a control 313, and a control 314. The control 312 is an inputting section (first inputting section) for inputting a numerical value of a vertical scaling ratio in the vertical direction of a print sheet, on which print data is to be printed by the printing apparatus 102. In the control 312, an up button 312a for increasing the value in the control 312 and a down button 312b for decreasing the value are vertically arranged side by side. Then, by appropriately pressing the up button 312a and the down button 312b, the user can change the value in the control 312 by 1 [%] with each operation, thereby setting the value to a desired magnitude. In the illustrated example in FIG. 3D, 100% is set by way of example. Note that the changing width of the numerical value, which can be changed by one operation of pressing the up button 312a or the down button 312b is not limited to 1 [%], but for example, the changing width can be e.g. 0.1 [%]. Further, in the control 312, a range of the numerical value which can be input to the control 312 is specified. With this, the user can input a numerical value in a range in the vertical direction, in which the independent scaling function can be executed. Although in FIG. 3D, the numerical value range is specified to “25% to 200%” by way of example but is not limited to this.

The control 313 is an input section (second input section) for inputting a numerical value of a horizontal scaling ratio in the horizontal direction of a print sheet on which print data is to be printed by the printing apparatus 102. In the control 313, an up button 313a for increasing the value in the control 313 and a down button 313b for decreasing the same are vertically arranged. Then, by appropriately pressing the up button 313a and the down button 313b, the user can change the value in the control 313 by 1 [%] with each operation, thereby setting the value to a desired magnitude. In FIG. 3D, 50% is set by way of example. Note that the changing width of the numerical value, which can be changed by one operation of pressing the up button 313a or the down button 313b is not limited to 1 [%], but, for example, the changing width can be e.g. 0.1 [%]. Further, in the control 313, a range of the numerical value which can be input to the control 313 is specified. With this, the user can input a numerical value in a range in the horizontal direction, in which the independent scaling function can be executed. Although in FIG. 3D, the numerical value range is specified to “25% to 200%” by way of example but is not limit to this.

The control 311 is a checkbox which is checked before a value is input to the control 310. The control 314 is a checkbox which is checked before values are input to the controls 312 and 313. In FIG. 3D, the control 314 is checked, and the control 311 is not checked by way of example. In this state, values can be input to the controls 312 and 313, but a value cannot be input to the control 310. Further, the control 310 is displayed in a grayed-out state. With this, it is possible to visualize a state in which inputting of a value to the control 310 is inhibited. The user can grasp that inputting of a value to the control 310 is inhibited by visually recognizing the control 310 displayed in the grayed-out state.

Here, a reason why the items included in the detailed setting screen 300B shown in FIG. 3B and the items included in the detailed setting screen 300C shown in FIG. 3C and the detailed setting screen 300D shown in FIG. 3D are different will be described. The items included in the detailed setting screen 300C shown in FIG. 3C and the items included in the detailed setting screen 300D shown in FIG. 3D are the same except differences in the input form of the value of the scaling ratio. Therefore, a reason why the items included in the detailed setting screen 300B and the items included in the detailed setting screen 300C are different will be described as a representative. The detailed setting screen 300B and the detailed setting screen 300C are generated based on respective pieces of the print function information (capabilities information). As described hereinabove, the general-purpose print software 202 does not support execution of the scaling function. Therefore, the scaling function cannot be added to the print function information only by the general-purpose print software 202. Further, even if the scaling function is originally included in the print function information, the general-purpose print software 202 cannot interpret the scaling function included in the print function information. For this reason, the scaling function settings cannot be displayed on the detailed setting screen. To cope with this, the print function-extending unit 206 adds the scaling function to the print function information 203. Then, the print setting screen-extending unit 205 displays the detailed setting screen 300C by referring to the capabilities information. With this, the extension application 204 can display sections for making settings of the scaling function on the detailed setting screen.

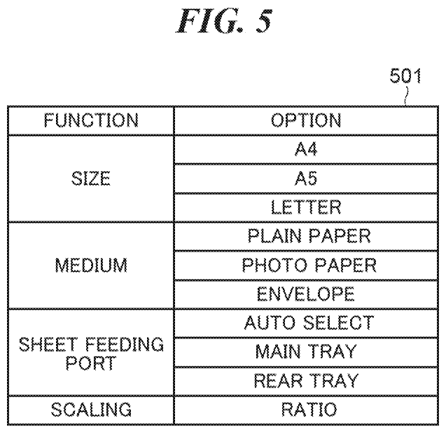

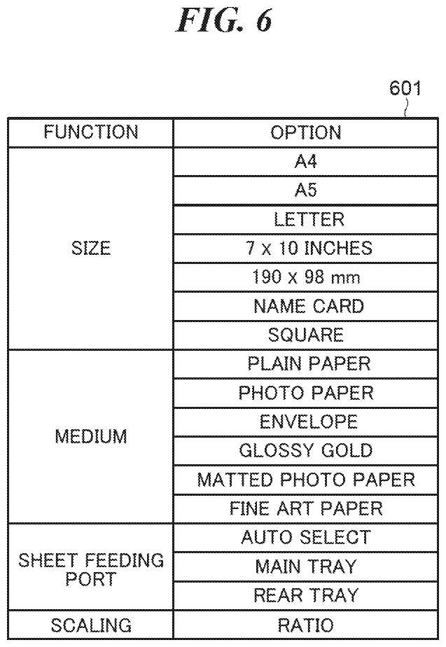

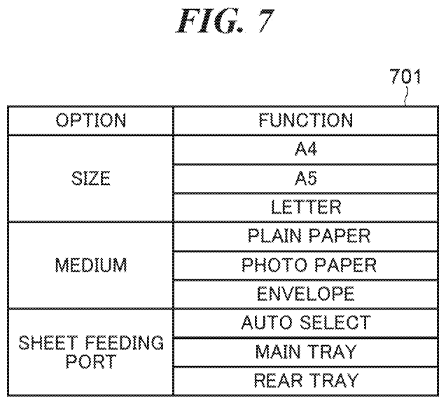

FIG. 4 is a flowchart of a process performed by the print function-extending unit 206, for editing the print function information. Note that a program of the process in FIG. 4 is executed by the CPU 111 that controls the print function-extending unit 206. FIG. 5 is a diagram showing an example of a list of the capabilities information of the printing apparatus 102. FIG. 6 is a diagram showing an example of a list of the print functions supported by the extension application. FIG. 7 is a diagram showing an example of a list of the capabilities information of the general-purpose print software. Referring to FIG. 4, in a step S401, the print function-extending unit 206 acquires the capabilities information from the printing apparatus 102 before the above-described display control step. The capabilities information is settings information included in a response acquired by issuing a “Get-Printer-Attributes” operation of the IPP to the printing apparatus 102. The settings information is formed by attribute information indicating the functions which can be designated in the printing apparatus 102, and settings related to this attribute information. A table 501 shown in FIG. 5 shows a list of the capabilities information of the printing apparatus 102. For example, the capabilities information includes information related to sizes of sheets to be used for printing performed by the printing apparatus 102. Further, the capabilities information includes information related to types of sheets (media) to be used for printing performed by the printing apparatus 102, information related to sheet feeding ports to be used for printing performed by the printing apparatus 102, and information related to the scaling function which can be executed by the printing apparatus 102.

In a step S402, the print function-extending unit 206 acquires print functions supported by the extension application 204 from the shared information 208. In the shared information 208, a list of the print functions supported by the extension application 204 is stored. This list includes all print functions which can be processed by the extension application 204 and settings of these print functions. A table 601 shown in FIG. 6 includes, as the print function, information related to sheet sizes supported by the extension application 204. The table 601 further includes information related to sheet types supported by the extension application 204, information related to sheet feeding ports supported by the extension application 204, and information related to the scaling function supported by the extension application 204. Further, the print functions supported by the extension application 204 are sometimes updated e.g. by the update of the extension application 204.

In a step S403, the print function-extending unit 206 acquires the print function information 203 generated by the general-purpose print software 202 from the OS. The print function information 203 is generated by the general-purpose print software 202 based on the capabilities information (see the table 501) acquired from the printing apparatus 102. The print function information 203 (PDC) generated by the general-purpose print software 202 includes only the print functions supported by the general-purpose print software 202, out of the capabilities information acquired from the printing apparatus 102. For example, the table 601 shown in FIG. 6 includes “7×10 inches” and “190× 98 mm” as the sheet sizes, but in a table 701 shown in FIG. 7, the general-purpose print software 202 does not support these sheet sizes. Therefore, these sheet sizes are not included in the print function information 203. Further, the table 601 shown in FIG. 6 includes the information related to the scaling function, but in the table 701 shown in FIG. 7, the general-purpose print software 202 does not support the scaling function. Therefore, the scaling function is not included in the print function information 203. By adding a function and/or an option to the print function information 203 by using the print function-extending unit 206, the extension application 204 can compensate for lack of the functions of the general-purpose print software 202. Further, the print function-extending unit 206 is also capable of deleting an unnecessary function and/or option from the print function information 203 generated by the general-purpose print software 202.

Steps S404, S405, and S406 are processing operations which are repeatedly executed on the list of the functions included in the capabilities information acquired from the printing apparatus 102 in the step S401. In the present embodiment, the steps S404, S405, and S406 are repeatedly executed on all of the 10 options included in the table 501.

In the step S404, the print function-extending unit 206 determines whether or not an option of a function, being currently selected for determination, exists in the print function information 203 generated by the general-purpose print software 202. If it is determined in the step S404 that the option of the function, being currently selected for determination, exists in the print function information 203, the present process is terminated if the option being selected for determination is the final item of the options of all the functions. Alternatively, if the option being selected for determination is not the final item of the options of all the functions, the next item of the options of the function or an option of the next function is selected, and the step S404 is executed again. On the other hand, if it is determined in the step S404 that the option of the function, being currently selected for determination, does not exist in the print function information 203, the process proceeds to the step S405. For example, in the present embodiment, the sheet size “A4” is included in the table 501, and the sheet size “A4” is also included in the table 701. In this case, it is determined in the step S404 that the option of the function, being currently selected for determination, exists in the print function information 203. On the other hand, “the scaling function” is included in the table 501 but is not included in the table 701. In this case, it is determined in the step S404 that the option of the function, being currently selected for determination, does not exist in the print function information 203.

In the step S405, the print function-extending unit 206 determines whether or not the option of the function, being currently selected for determination, exists in the options of the functions supported by the extension application 204. If it is determined in the step S405 that the option of the function being currently selected for determination exists, the process proceeds to the step S406. On the other hand, if it is determined in the step S405 that the option of the function being currently selected for determination does not exist, similar to the case where the answer to the question of the step S404 is affirmative (YES), the present process is terminated if the option being selected for determination is the final item of the options of all the functions. Alternatively, if the option being selected for determination is not the final item of the options of all the functions, the next item of the options of the function or an option of the next function is selected, and the step S404 is executed again. For example, in the present embodiment, in a case where the option of the function being currently selected for determination is related to “the scaling function”, the option related to “the scaling function” also exists in the table 601. Therefore, it is determined in the step S405 that the option of the function being currently selected for determination exists.

In the step S406, the print function-extending unit 206 adds the function and its option being currently selected for determination to the print function information 203. After execution of the step S406, similar to the case where the answer to the question of the step S404 is affirmative (YES), the present process is terminated if the option being selected for determination is the final item of the options of all the functions. Alternatively, if the option being selected for determination is not the final item of the options of all the functions, the next item of the options of the function or an option of the next function is selected, and the step S404 is executed again.

As described above, the extension application 204 can add, to the print function information 203, a function (and its options) which are not supported by the general-purpose print software 202 but are supported by the printing apparatus 102, and at the same time are supported by the extension application 204. Then, the capabilities information (PC) is generated based on the print function information 203 edited by this addition processing. By generating a display screen based on the resulting capabilities information, the print setting screen-extending unit 205 can extend the function not supported by the general-purpose print software 202 and display the detailed setting screen 300C or the detailed setting screen 300D.

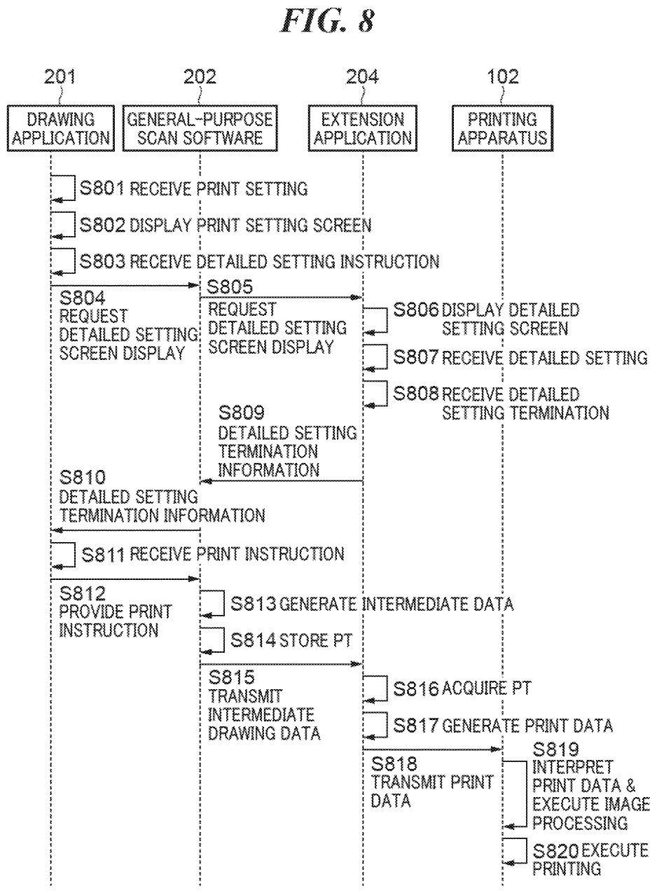

FIG. 8 is a sequence diagram showing a process executed between the drawing application 201, the general-purpose print software 202, the extension application 204, and the printing apparatus 102, after the drawing application 201 receives the print settings. Processing operations by the drawing application 201, the general-purpose print software 202, and the extension application 204 are executed by the CPU 111 of the host computer 101. The processing programs are stored in the external storage device 114. The CPU 111 loads the processing programs from the external storage device 114 into the RAM 113 and executes the loaded programs. Further, processing operations performed by the printing apparatus 102 are executed by the CPU (not shown) of the printing apparatus 102. Further, the software configuration of the printing system 1000 is the software configuration shown in FIG. 2A-B.

Referring to FIG. 8, in a step S801, the drawing application 201 receives print settings provided by the user. The user can instruct the print settings to the drawing application 201 by operating e.g. the pointing device 117 and/or the keyboard 118.

In a step S802, the drawing application 201 displays the print setting screen 300A shown in FIG. 3A on the display section 119.

In a step S803, the drawing application 201 receives a detailed setting instruction provided by the user. The user can instruct display of the detailed setting screen by operating e.g. the pointing device 117 and/or the keyboard 118 to select the control 305 on the print setting screen 300A.

In a step S804, the drawing application 201 requests the general-purpose print software 202 to display the detailed setting screen.

In a step S805, the general-purpose print software 202 requests the extension application 204 to display the detailed setting screen.

In a step S806, the print setting screen-extending unit 205 of the extension application 204 displays the detailed setting screen 300C shown in FIG. 3C. As described hereinabove, the scaling function is added to the print function information 203 (PDC) by the print function-extending unit 206. The print setting screen-extending unit 205 can display the detailed setting screen 300C by referring to the capabilities information (PC) generated based on the print function information 203 to which the scaling function has been added.

In a step S807, the print setting screen-extending unit 205 receives detailed settings input by the user on the detailed setting screen 300C. Note that it is assumed here that, on the detailed setting screen 300C, the sheet type “plain paper” is selected by the control 306, the sheet size “A4” is selected by the control 307, and the sheet feeding port “auto” is selected by the control 308 by way of example (see FIG. 3C). Further, “200 [%]” is input in the control 310. In this setting state, the print setting screen-extending unit 205 receives the operation of the control 309, performed by the user, on the detailed setting screen 300C.

In a step S808, the print setting screen-extending unit 205 receives termination of the detailed setting operation performed by the user based on the operation of the control 309 in the step S807. The user can instruct termination of the detailed setting operation by selecting the control 309 through operating e.g. the pointing device 117 and/or the keyboard 118.

In a step S809, the extension application 204 transmits detailed setting termination information to the effect that the detailed setting operation in the S808 has been terminated, to the general-purpose print software 202.

In a step S810, the general-purpose print software 202 receives the detailed setting termination information sent from the extension application 204 in the step S809. Then, the general-purpose print software 202 transmits this detailed setting termination information to the drawing application 201.

In a step S811, the drawing application 201 receives a print instruction provided by the user. The user can instruct printing by operating e.g. the pointing device 117 and/or the keyboard 118 to select the control 303 on the print setting screen 300A (see FIG. 3A).

In a step S812, the drawing application 201 provides the print instruction received in the step S811 to the general-purpose print software 202.

In a step S813, the general-purpose print software 202 generates intermediate data based on the print instruction received in the step S812 by using a module of the OS.

In a step S814, the general-purpose print software 202 stores the print setting information (PT) based on the print instruction received in the step S812, in the shared information 208.

In a step S815, the general-purpose print software 202 transmits drawing data, out of the intermediate data (intermediate drawing data) generated in the step S813, to the extension application 204.

In a step S816, the intermediate data-editing unit 207 of the extension application 204 acquires the print setting information stored in the step S814 from the shared information 208.

In a step S817, the intermediate data-editing unit 207 of the extension application 204 generates print data using the drawing data transmitted in the step S815 and the print setting information acquired in the step S816. This print data is data including a value (value information) of the scaling ratio, which has been received on the detailed setting screen 300C.

In a step S818, the intermediate data-editing unit 207 of the extension application 204 transmits the print data generated in the step S817 to the printing apparatus 102. As described hereinabove, the print data includes the value information of the scaling ratio, which has been received on the detailed setting screen 300C.

In a step S819, the printing apparatus 102 receives the print data transmitted in the step S818. The printing apparatus 102 interprets the print data and performs necessary image processing on the print data. As the image processing performed here, the processing for enlarging/reducing the print data at the scaling ratio based on the value information transmitted in the step S818.

In a step S820, the printing apparatus 102 prints the print data on which the image processing has been performed in the step S819. With this, the printed matter becomes a printed matter of the print data which has been enlarged/reduced at the scaling ratio received on the detailed setting screen 300C.

As described above, in the printing system 1000, even in a case where the general-purpose print software 202 does not support the scaling function, the extension application 204 can display the detailed setting screen 300C shown in FIG. 3C. With the detailed setting screen 300C, it is possible to change a numerical value of the scaling ratio, which is set when the print data is enlarged/reduced and printed by the printing apparatus 102. Then, the printing apparatus 102 can execute the scaling function based on the scaling ratio (value information) set on the detailed setting screen 300C. As a result, a printed matter of print data which has been enlarged/reduced at the scaling ratio is printed from the printing apparatus 102. Note that in the description given with reference to FIG. 8, assuming that the software configuration of the printing system 1000 is the software configuration shown in FIG. 2A-B, the detailed setting screen 300C shown in FIG. 3C is displayed, but this is not limitative. For example, in a case where the display of the detailed setting screen is requested to the general-purpose print software 202 in the step S804, the general-purpose print software 202 displays the detailed setting screen 300B shown in FIG. 3B. In this case, after the control 309 on the detailed setting screen 300B is operated, the general-purpose print software 202 requests the extension application 204 to display an additional detailed setting screen. Then, the extension application 204 can additionally display a detailed setting screen on which the scaling function can be executed. Further, although, in the present embodiment, the extension application 204 generates print data from the intermediate data generated by the general-purpose print software 202, this is not limitative, but, for example, the extension application 204 itself can generate intermediate data.

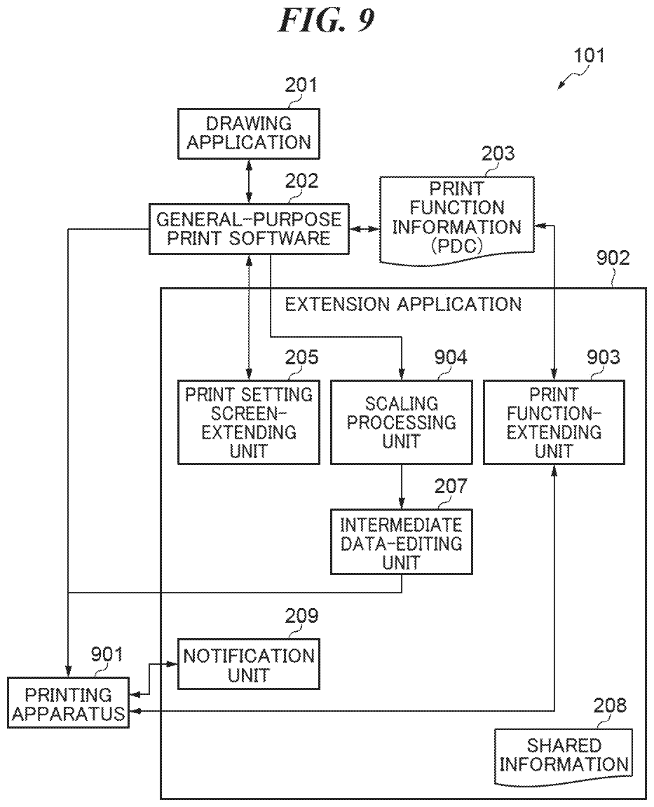

A second embodiment will be described below with reference to FIGS. 9 to 12, but the description will be given mainly of different points from the above-described first embodiment, and description of the same points is omitted. In the first embodiment, the extension application 204 generates print data including the scaling ratio in cooperation with the general-purpose print software 202. This print data is transmitted to the printing apparatus 102. The printing apparatus 102 can interpret the print data including the scaling ratio and execute the scaling function. As described above, in the first embodiment, the extension application 204 causes the printing apparatus 102 to execute the scaling function in cooperation with the general-purpose print software 202.

However, some printing apparatus 102 is incapable of executing the scaling function. In this case, even when the extension application 204 generates print data including the scaling ratio, it is impossible to cause the printing apparatus 102 to execute the scaling function. In a case where printing apparatus 102 cannot execute the scaling function, it is preferable that the extension application 204 generates print data on which the scaling function has been performed and transmits the print data thus generated to the printing apparatus 102.

Therefore, in the present embodiment, whether or not the scaling function can be executed by the printing apparatus 102 is determined based on the capabilities information of the printing apparatus 102. As a result of this determination, if it is determined that the scaling function can be executed by the printing apparatus 102, the extension application 204 generates print data including the scaling ratio and transmits the print data to the printing apparatus 102. On the other hand, if it is determined that the scaling function cannot be executed by the printing apparatus 102, the extension application 204 generates print data including drawing data on which the scaling function has been executed, i.e., execution of the scaling function has been reflected, and transmits the print data to the printing apparatus 102. With this, even in a case where the scaling function cannot be executed by the printing apparatus 102, it is possible to provide the scaling function for the user. Note that the present embodiment is the same as the first embodiment except differences in the configuration of the printing system 1000 in the case where the extension application 204 is associated, the PDC editing process, and the process after the drawing application 201 receives the print setting.

FIG. 9 is a block diagram showing a software configuration of the printing system 1000 according to the second embodiment. The block diagram shown in FIG. 9 is a diagram showing a configuration in a case where an extension application 902 is associated with the general-purpose print software 202 and a printing apparatus 901. As shown in FIG. 9, the host computer 101 includes the drawing application 201, the general-purpose print software 202, the print function information 203, and the extension application 902. Further, the extension application 902 is communicably connected to the printing apparatus 901. Different from the printing apparatus 102 in the first embodiment, the printing apparatus 901 is a printing apparatus incapable of executing the scaling function. The extension application 902 includes the print setting screen-extending unit 205, the intermediate data-editing unit 207, the shared information 208, the notification unit 209, a print function-extending unit 903, and a scaling processing unit 904. The print function-extending unit 903 can add the scaling function to the print function information 203 even in a case where it is determined, based on the capabilities information acquired from the printing apparatus 901, that the scaling function cannot be executed by the printing apparatus 901. The scaling processing unit 904 performs the scaling processing on intermediate data (drawing data) received from the general-purpose print software 202 based on the scaling ratio set by the user.

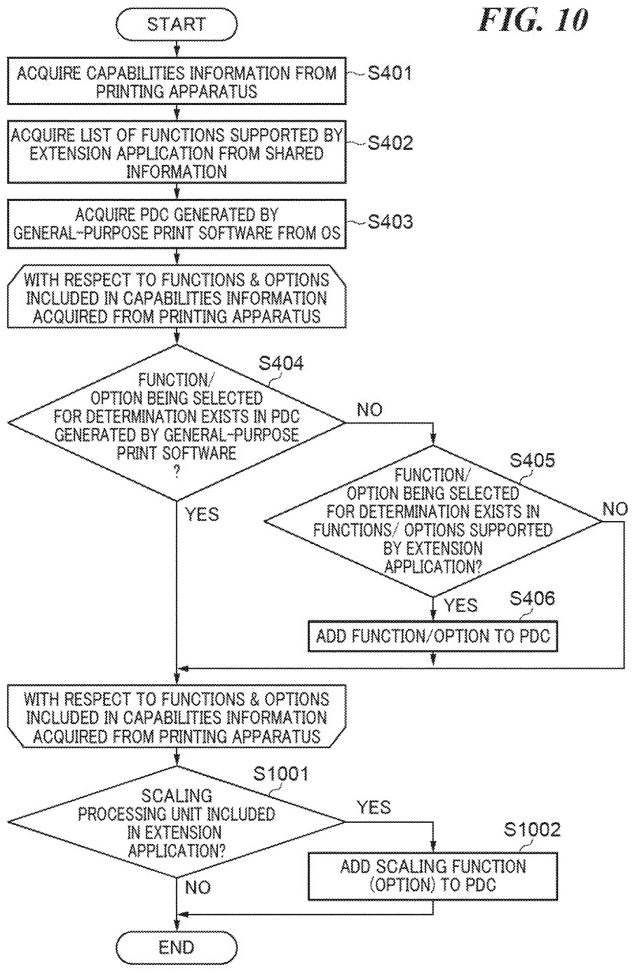

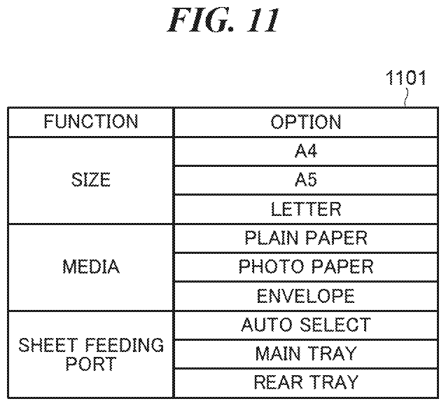

FIG. 10 is a flowchart of a process performed by the print function-extending unit for editing the print function information. Note that a program of the process in FIG. 10 is executed by the CPU 111 that controls the print function-extending unit 903. Further, in the process in FIG. 10, steps S1001 and S1002 are added to the process in FIG. 4. FIG. 11 is a diagram showing an example of a list of the capabilities information of the printing apparatus. Referring to FIG. 10, in a case where repetition of the steps S404 to S406 is terminated, the process proceeds to the step S1001. A table 1101 shown in FIG. 11 shows a list of the capabilities information of the printing apparatus 901. This table 1101 includes, as capabilities information, the information related to sheet sizes, the information related to sheet types, and the information related to sheet feeding ports, but is different from the table 501 shown in FIG. 5 in that the information related to the scaling function is not included. Therefore, it is understood that the printing apparatus 901 is not capable of executing the scaling function. For this reason, the scaling function is not added to the print function information 203 after the processing operations in the steps S404 to S406 are terminated.

As shown in FIG. 10, in the step S1001, the print function-extending unit 903 determines whether or not the scaling processing unit 904 is included in the extension application 902, i.e. presence/absence of the scaling processing unit 904. If it is determined in the step S1001 that the scaling processing unit 904 is included, the process proceeds to the step S1002. On the other hand, if it is determined in the step S1001 that the scaling processing unit 904 is not included, the process is terminated. As described above, the extension application 902 includes the scaling processing unit 904, and hence the process proceeds to the step S1002.

In the step S1002, the print function-extending unit 903 adds the information related to the scaling function in the table 601 shown in FIG. 6, to the print function information 203.

As described above, the extension application 902 can add, to the print function information 203, a function (and its options) which are not supported by the general-purpose print software 202 but are supported by the printing apparatus 901, and at the same time are supported by the extension application 204. Then, the extension application 902 determines presence/absence of the scaling processing unit 904. As a result of this determination, if it is determined that the scaling processing unit 904 is present, the scaling function is added to the print function information 203. With this addition processing, even in a case where the scaling function cannot be executed by the printing apparatus 901, the capabilities information is generated based on the print function information 203 to which the scaling function has been added. The extension application 902 can display the detailed setting screen 300C shown in FIG. 3C by generating a display screen based on the capabilities information.

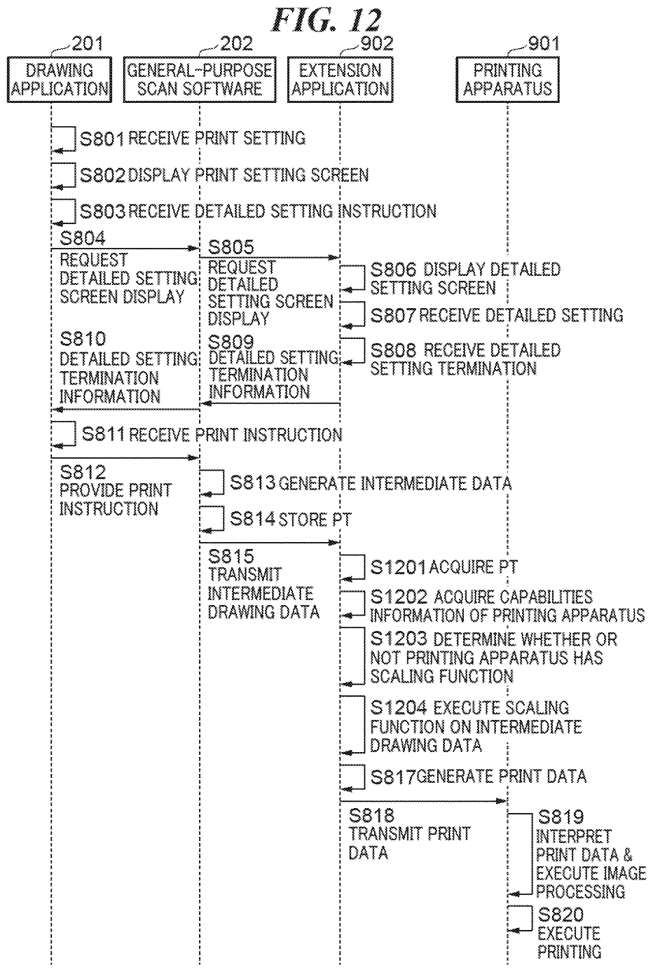

FIG. 12 is a sequence diagram showing a process executed between the drawing application 201, the general-purpose print software 202, the extension application 204, and the printing apparatus 102, after the drawing application 201 receives the print settings. The sequence diagram shown in FIG. 12 is a sequence diagram mainly configured by adding steps S1201 to S1204 to the sequence diagram shown in FIG. 8. Referring to FIG. 12, after execution of the step S815, the process proceeds to the step S1201. In the step S1201, the scaling processing unit 904 of the extension application 902 acquires the print setting information (PT) stored in the step S814 from the shared information 208. Further, the scaling processing unit 904 acquires the information related to the scaling function, which is included in the print setting information. Note that in a case where the scaling ratio in the information related to the scaling function is set to a value of 100 [%], the scaling processing is not executed, and hence the process skips the steps S1202 to S1204.

In the step S1202, the scaling processing unit 904 acquires the capabilities information of the printing apparatus 901 from the shared information 208. Note that in a case where the capabilities information of the printing apparatus 901 is not included in the shared information 208, the print function-extending unit 903 can request the capabilities information to the printing apparatus 901. In this case as well, the capabilities information is stored in the shared information 208.

In the step S1203, the scaling processing unit 904 determines, based on the capabilities information acquired in the step S1202, whether or not the scaling function can be executed by the printing apparatus 901. As described above, in the present embodiment, the printing apparatus 901 is incapable of executing the scaling function. Therefore, it is determined in the step S1203 that the scaling function cannot be executed by the printing apparatus 901. Note that if it is determined in the step S1203 that the scaling function can be executed by the printing apparatus 901, the process skips the step S1204 and proceeds to the step S817. This is because, in general, the printing apparatus 901 can perform the scaling function at higher speed than the scaling processing unit 904. Specifically, the printing apparatus 901 can perform the scaling processing at higher speed than the scaling processing unit 904 by using an Application Specific Integrated Circuit (ASIC).

In the step S1204, the scaling processing unit 904 generates scaling data by enlarging/reducing the intermediate drawing data (intermediate data) at the scaling ratio based on the information related to the scaling function setting, which is acquired in the step S1201. This processing result is stored in the shared information 208. Further, the scaling processing unit 904 edits the scaling ratio in the print setting information to “100” or deletes the scaling ratio from the print setting information. After execution of the step S1204, the process sequentially proceeds to the steps S817 to S820. Note that the print data transmitted in the step S818 is the scaling data generated in the step S1204. Then, a printed matter obtained in the step S820 is a printed matter on which the scaling function has been executed, i.e., scaling has been reflected.

As described above, in the present embodiment, even in a case where the scaling function cannot be executed by the printing apparatus 901, the extension application 902 can execute the scaling function. This makes it possible for even the printing apparatus 901 to print a printed matter on which execution of the scaling function is reflected.

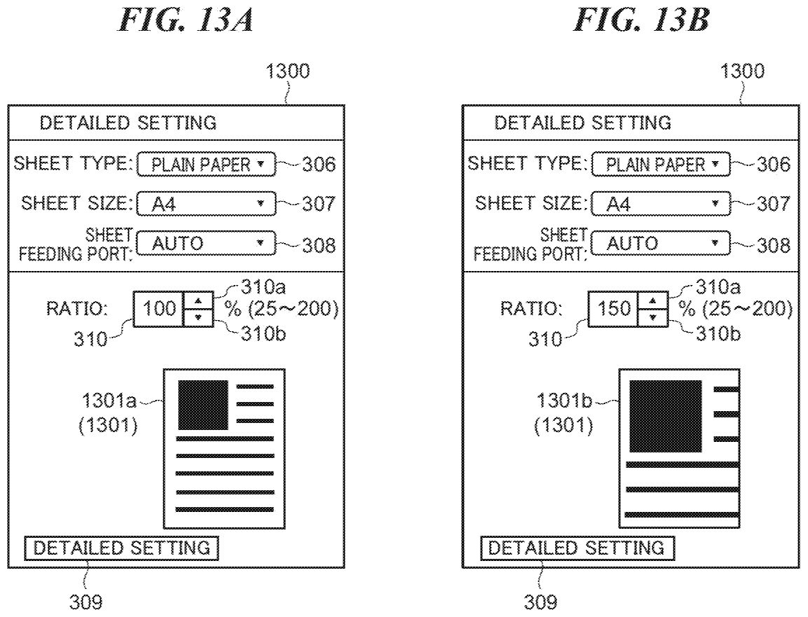

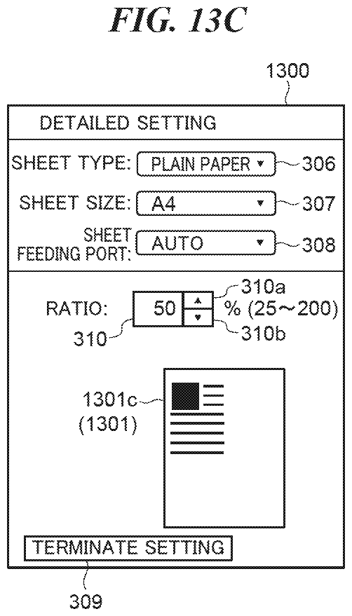

A third embodiment will be described below with reference to FIGS. 13A to 13C, but the description will be given mainly of different points from the above-described embodiments, and description of the same points is omitted. The present embodiment is the same as the first embodiment except differences in the configuration of the detailed setting screen.

FIGS. 13A to 13C are diagrams each showing an example of a screen displayed on the display section of the printing system according to the third embodiment. FIG. 13A shows a detailed setting screen in a case where the scaling ratio is set to 100 [%]. FIG. 13B shows a detailed setting screen in a case where the scaling ratio is set to 150 [%]. FIG. 13C shows a detailed setting screen in a case where the scaling ratio is set to 50 [%]. As shown in FIGS. 13A to 13C, the detailed setting screen, denoted by reference numeral 1300, includes a preview image 1301 of a printed matter to be obtained by printing print data by the printing apparatus 102. Note that, different from a general preview image, the preview image 1301 is a simple preview image generated by enlarging/reducing a specific illustration image according to the designated scaling ratio. With this, the preview image 1301 can be displayed at a higher speed than when a general preview image is displayed. Note that although the preview image 1301 is arranged below the control 310 in the configuration shown in FIGS. 13A to 13C, this is not limitative.

As shown in FIG. 13A, 100 [%] is input in the control 310 on the detailed setting screen 1300 as the scaling ratio. A preview image 1301a in this case becomes an image of print data which has not been scaled. As shown in FIG. 13B, 150 [%] is input in the control 310 on the detailed setting screen 1300 as the scaling ratio. A preview image 1301b in this case becomes an image of print data, on which the scaling ratio of 150 [%] has been reflected, i.e., which has been enlarged to 150 [%]. Note that the preview image 1301b becomes an image of an upper left area of the preview image 1301a. As shown in FIG. 13C, 50 [%] is input in the control 310 on the detailed setting screen 1300 as the scaling ratio. A preview image 1301c in this case becomes an image of print data, on which the scaling ratio of 50 [%] has been reflected, i.e., which has been reduced to 50 [%]. Note that the preview image 1301c becomes an image on which the image of the whole print data is arranged in an upper left area of the sheet. With the preview images 1301a to 1301c, the user can grasp the state of the printed matter to be printed by the printing apparatus 102 before the printing.

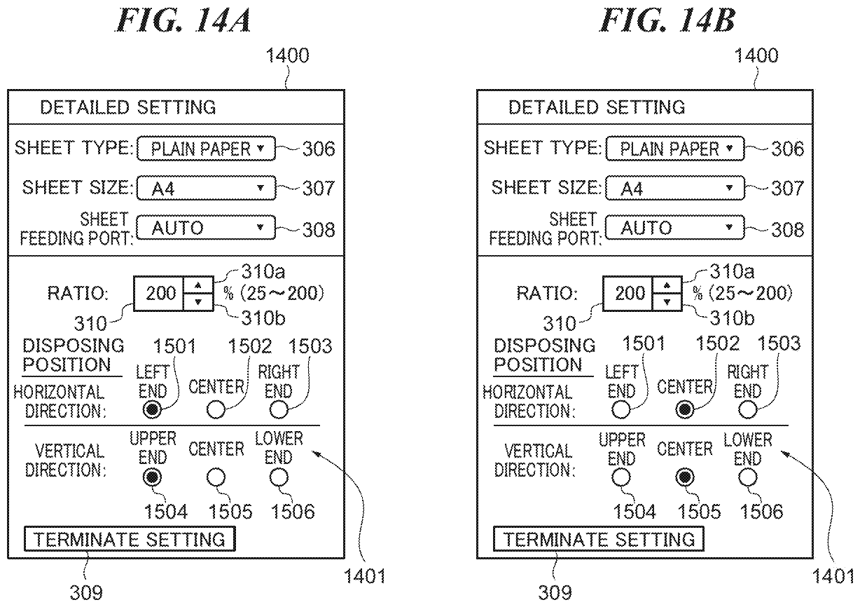

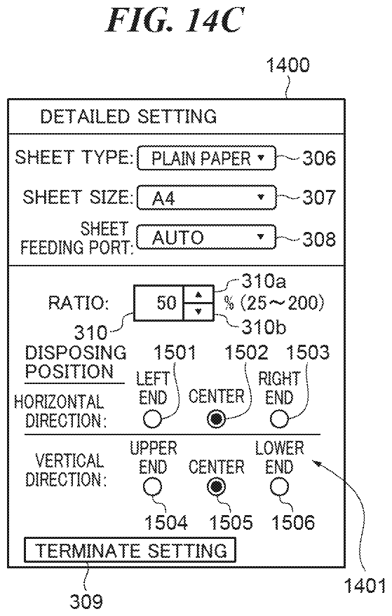

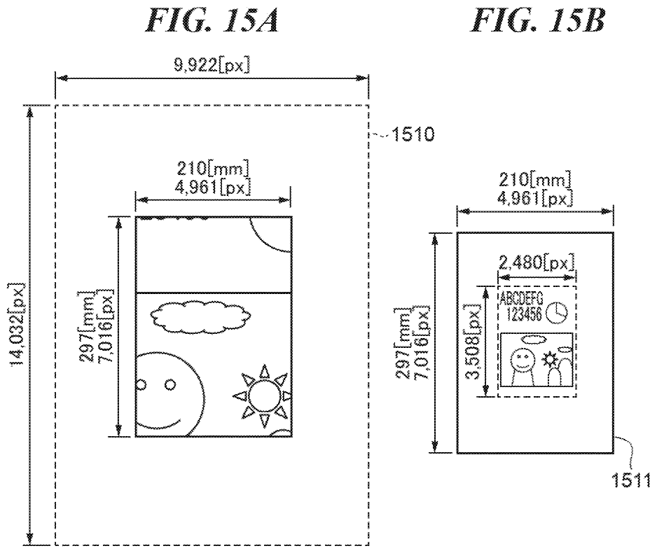

A fourth embodiment will be described below with reference to FIGS. 14A to 14C and FIGS. 15A and 15B, but the description will be given mainly of different points from the above-described embodiments, and description of the same points is omitted.

FIGS. 14A to 14C are diagrams each showing an example of a screen displayed on the display section of the printing system according to the fourth embodiment. FIG. 14A shows a detailed setting screen in a case where the scaling ratio is set to 200 [%], and the disposing position of the print data is set to the left end in the horizontal direction and the upper end in the vertical direction. FIG. 14B shows a detailed setting screen in a case where the scaling ratio is set to 200 [%], and the disposing position of the print data is set to the center in the horizontal direction and the center in the vertical direction. FIG. 14C shows a detailed setting screen in a case where the scaling ratio is set to 50 [%], and the disposing position of the print data is set to the center in the horizontal direction and the center in the vertical direction. FIGS. 15A and 15B are diagrams each showing an example of a printing position of print data on a print sheet. As shown in FIGS. 14A to 14C, a setting reception screen 1400 includes an adjustment section 1401 for adjusting the printing position of print data on a print sheet on which the print data is to be printed by the printing apparatus 102. This adjustment section 1401 includes controls 1501 to 1506. The control 1501 is a checkbox (left end designation section) which is checked when desired to designate the left end in the horizontal direction as the printing position of the print data on the print sheet. The control 1502 is a checkbox (center designation section) which is checked when desired to designate the center. The control 1503 is a checkbox (right end designation section) which is checked when desired to designate the right end. The control 1504 is a checkbox (upper end designation section) which is checked when desired to designate the upper end in the vertical direction as the printing position of the print data on the print sheet. The control 1505 is a checkbox (center designation section) which is checked when desired to designate the center. The control 1506 is a checkbox (lower end designation section) which is checked when desired to designate the lower end. Thus, in the adjustment section 1401, the user can select a printing position of print data in the horizontal direction of the print sheet from three (a plurality of types of) options, and select a printing position of print data in the vertical direction of the print sheet from three (a plurality of types of) options. Note that the number of options in each direction is not limited to three. Further, although the adjustment section 1401 is arranged below the control 310 in the configuration shown in FIGS. 14A to 14C, this is not limitative.

On the setting reception screen 1400 shown in FIG. 14A, 200 [%] is input in the control 310, and the control 1501 and the control 1504 are checked. In this input state, for example, as shown in FIG. 2B-B, the print data is printed such that the print data after being subjected to the enlargement processing is positioned on the upper left of the print sheet 2001. On the setting reception screen 1400 shown in FIG. 14B, 200 [%] is input in the control 310, and the control 1502 and the control 1505 are checked. In this input state, as shown in FIG. 15A, the print data is printed such that the print data after being subjected to the enlargement processing is positioned in the center of a print sheet 1510. On the setting reception screen 1400 shown in FIG. 14C, 50 [%] is input in the control 310, and the control 1502 and the control 1505 are checked. In this input state, as shown in FIG. 15B, the print data is printed such that the print data after being subjected to the reduction processing is positioned in the center of a print sheet 1511. Note that although the adjustment section 1401 is formed by the controls 1501 to 1506, this is not limitative. For example, the adjustment section 1401 can be configured such that the printing position of print data on a print sheet can be designated by using e.g. a mouse and/or a touch panel. Further, the adjustment section 1401 can be configured such that the printing position of print data on a print sheet can be input by numerical values. As the numerical values in this case, for example, it is preferable that a distance [mm] from the upper end of the print sheet and a distance [mm] from the left end of the print sheet are input.

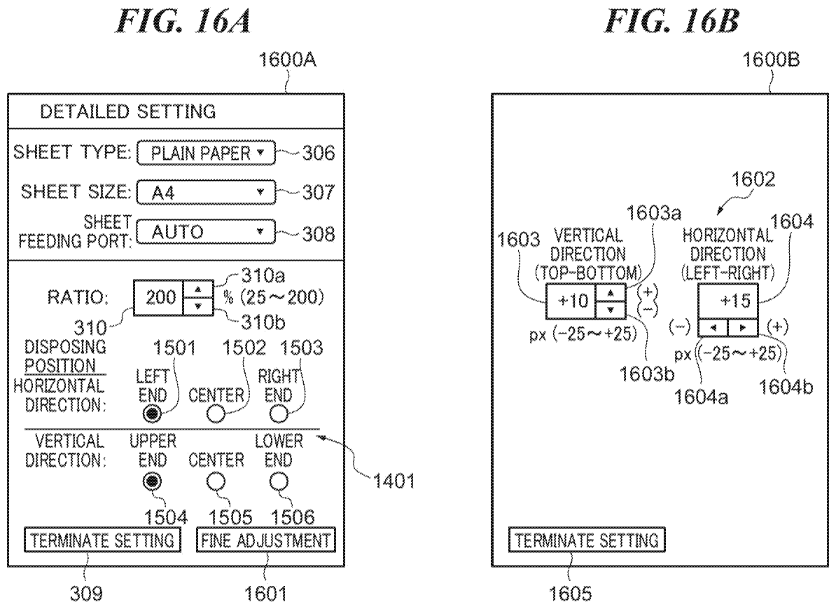

A fifth embodiment will be described below with reference to FIGS. 16A and 16B, but the description will be given mainly of different points from the above-described embodiments, and description of the same points is omitted.

FIGS. 16A and 16B are diagrams each showing an example of a screen displayed on the display section of the printing system according to the fifth embodiment. FIG. 16A shows a detailed setting screen in a case where the scaling ratio is set to 200 [%], and the disposing position of print data is set to the left end in the horizontal direction and the upper end in the vertical direction. FIG. 16B shows a detailed setting screen shifted from the detailed setting screen shown in FIG. 16A. As shown in FIG. 16A, the detailed setting screen, denoted by reference numeral 1600A, includes a control 1601. The control 1601 is a button operated when the user further finely adjusts the printing position of print data, designated in the adjustment section 1401. By operating the control 1601, the detailed setting screen 1600A shifts to the detailed setting screen, denoted by reference numeral 1600B, shown in FIG. 16B. The detailed setting screen 1600B includes a fine adjustment section 1602. This fine adjustment section 1602 includes a control 1603 and a control 1604. Note that although the controls 1603 and 1604 are horizontally arranged side by side on the detailed setting screen 1600B, this is not limitative. Further, the controls 1603 and 1604 can be included in the detailed setting screen 1600A. In this case, the controls 1603 and 1604 are preferably displayed in a grayed-out state until the control 1601 is operated. Then, in a case where the control 1601 is operated, the controls 1603 and 1604 are released from the grayed-out display and enabled to receive an input of numerical values.

The control 1603 is an input section for inputting a numerical value of a fine adjustment position of print data in the vertical direction (top-bottom direction) of the print sheet. In the control 1603, an up button 1603a for increasing the value in the control 1603 and a down button 1603b for decreasing the value are vertically arranged side by side. Then, by appropriately pressing the up button 1603a and the down button 1603b, the user can change the value in the control 1603 by 1 [px] with each operation, thereby setting the value to a desired magnitude. In FIG. 16B, “+10” is set by way of example. Note that the changing width of the numerical value, which can be changed by one operation of pressing the up button 1603a or the down button 1603b is not limited to 1 [px], but for example, the changing width can be e.g. 2 [px]. Further, in the control 1603, a range of the numerical value which can be input to the control 1603 is specified. With this, the user can input a numerical value in a range, which can be finely adjusted. Although in FIG. 16B, the numerical value range is specified to “−25 [px] to +25 [px]”, this is not limitative.

The control 1604 is an input section for inputting a numerical value of a fine adjustment position of print data in the horizontal direction (right-left direction) of the print sheet. In the control 1604, an up button 1604a for increasing the value in the control 1604 and a down button 1604b for decreasing the value are horizontally arranged side by side. Then, by appropriately pressing the up button 1604a and the down button 1604b, the user can change the value in the control 1604 by 1 [px] with each operation, thereby setting the value to a desired magnitude. In FIG. 16B, “+15” is set by way of example. Note that the changing width of the numerical value, which can be changed by one operation of pressing the up button 1604a or the down button 1604b is not limited to the same changing width as that of the control 1603, but, for example, the changing width can be different from that of the control 1603. Further, in the control 1604, a range of the numerical value which can be input to the control 1604 is specified. With this, the user can input a numerical value in a range within which the numerical value can be finely adjusted. Although in FIG. 16B, similar to the control 1603, the numerical value range is specified to “−25 [px] to +25 [px]”, this is not limitative. Further, the detailed setting screen 1600B includes a control 1605. The control 1605 is a button for finalizing the fine adjustment with the input values in the controls 1603 and1604. Further, by operating the control 1605, the detailed setting screen 1600B shifts to the detailed setting screen 1600A.

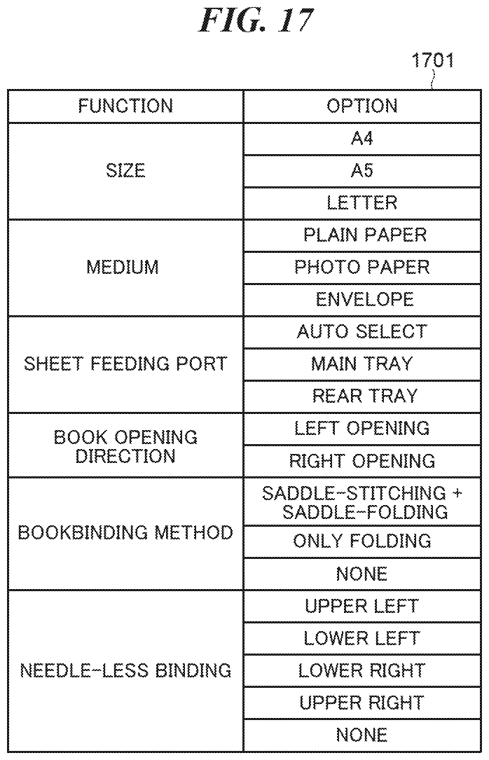

A sixth embodiment will be described below with reference to FIGS. 17 to 19, but the description will be given mainly of different points from the above-described embodiments, and description of the same points is omitted. As described above, the host computer 101 includes the general-purpose print software 202 operating according to the IPP and the extension application 204 supporting the general-purpose print software 202. In the present embodiment, the general-purpose print software 202 cannot receive a binding setting for binding a plurality of print sheets (printing media) which have been printed by the printing apparatus 102, i.e. cannot cause the printing apparatus 102 to execute a bookbinding function or a needle-less binding function. On the other hand, the extension application 204 can receive the binding setting which cannot be received by the general-purpose print software 202 by causing the CPU 111 to execute steps (control method), described hereinafter. Further, in the present embodiment, the printing apparatus 102 is a printing system having a finisher that is capable of executing the bookbinding function and the needle-less binding function.

FIG. 17 is a diagram showing an example of a list of the capabilities information of the printing apparatus according to the sixth embodiment. A table 1701 shown in FIG. 17 shows a list of the capabilities information of the printing apparatus 102. Similar to the first embodiment (see FIG. 5), the capabilities information includes the information related to sizes of sheets (print sheets), the information related to types of sheets (media), and the information related to sheet feeding ports. Further, in the present embodiment, the other capabilities information includes information related to a direction (book opening direction) of opening a plurality of print sheets in a state in which the plurality of print sheets have been bound and information related to a method (bookbinding method) of binding the plurality of print sheets are included. Further, the other capabilities information includes information related to a binding position when a plurality of print sheets are bound without using a binding tool, such as staples of a stapler, (needle-less binding). Note that the capabilities information of the general-purpose print software 202 in the present embodiment includes the information related to sheet sizes, the information related to sheet types, and the information related to sheet feeding ports but does not include the information related to the book opening direction, the information related to the bookbinding method, or the information related to the needle-less binding. Further, the print function-extending unit 206 (see FIG. 4) adds the information related to the book opening direction, the information related to the bookbinding method, and the information related to the needle-less binding, to the print function information 203. With this, the extension application 204 can support the function of binding a plurality of print sheets which have been printed.

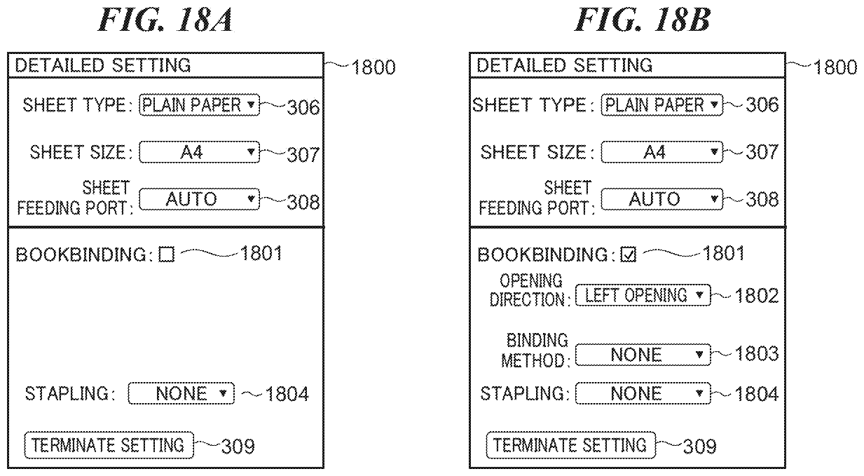

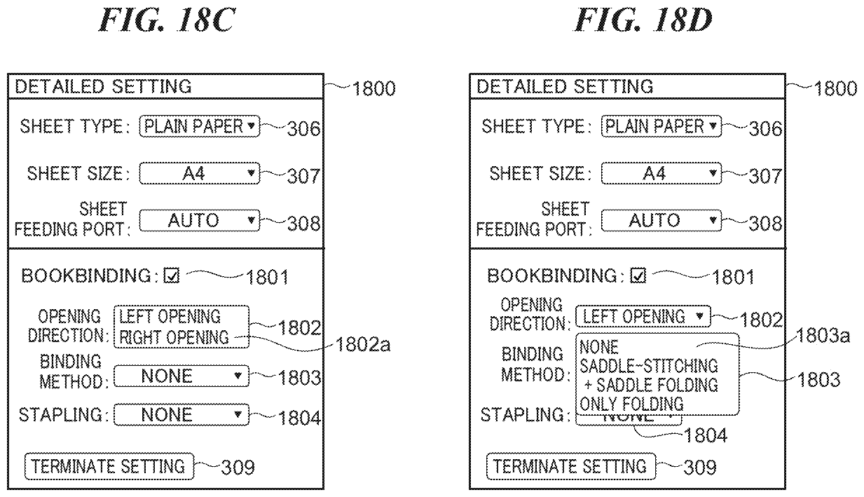

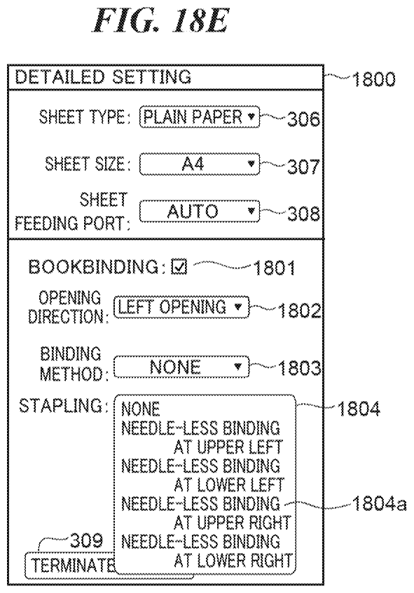

FIGS. 18A to 18E are diagrams each showing an example of a screen displayed on the display section of the printing system. A detailed setting screen (setting reception screen) 1800 shown in FIGS. 18A to 18E is a screen for receiving a binding setting, i.e. a setting for causing the printing apparatus 102 to execute the bookbinding function and the needle-less binding function. This detailed setting screen 1800 is displayed on the display section 119 by the print setting screen-extending unit 205. The detailed setting screen 1800 shown in FIG. 18A is a screen in an initial state. This detailed setting screen 1800 includes the controls 306 to 309. Further, the detailed setting screen 1800 additionally includes controls 1801 and 1804. The control 1801 is a switching section for switching whether to enable or disable execution of the binding setting for the printing apparatus 102, i.e., execution of the bookbinding function in the printing apparatus 102. In a state in which a checkbox included in the control 1801 is checked, execution of the bookbinding function is set enabled, and the detailed setting screen 1800 is shifted to a state shown in FIG. 18B. Note that in a state in which the checkbox of the control 1801 is unchecked, execution of the bookbinding function is disabled.

To the detailed setting screen 1800 in the state shown in FIG. 18B, the controls 1802 and 1803 are added. The control 1802 is an opening direction-setting section for setting a direction in which a plurality of print sheets are opened in a state book-bound into a booklet style. By pressing the control 1802, a popup menu 1802a appearing in FIG. 18C is developed and displayed on the control 1802. The popup menu 1802a includes options of “left opening” and “right opening”. This corresponds to the table 1701 (see FIG. 17). In a case where the left opening is selected, the booklet formed by the plurality of print sheets which have been book-bound is bound on its right side in a state in which the front cover of the booklet is oriented to the front side, and the left side of the booklet is opened. In a case where the right opening is selected, the booklet formed by the plurality of print sheets which have been book-bound is bound on its left side in a state in which the front cover of the booklet is oriented to the front side, and the right side of the booklet is opened. Note that the popup menu 1802a is not limited to include “left opening” and “right opening”, but depending on the configuration of the printing apparatus 102 (printing system), for example, “top opening” and “bottom opening” can be included. In a case where the top opening is selected, the booklet formed by the plurality of print sheets which have been book-bound is bound on its bottom side in a state in which the front cover of the booklet is oriented to the front side, and the top side is opened. In a case where the bottom opening is selected, the booklet formed by the plurality of print sheets which have been book-bound is bound on its top side in a state in which the front cover of the booklet is oriented to the front side, and the bottom side is opened.

The control 1803 is a binding method-setting section for setting a method of binding a plurality of print sheets into a booklet style (binding method). By pressing the control 1803, a popup menu 1803a appearing in FIG. 18D is developed and displayed on the control 1803. The popup menu 1803a includes options of “none”, “saddle-stitching+saddle-folding”, and “only folding”. This corresponds to the table 1701 (see FIG. 17). In a case where “none” is selected, the plurality of print sheets are simply stacked and then discharged. In a case where “saddle-stitching+saddle-folding” is selected, the plurality of print sheets are stapled in a state in which each print sheet is folded into two and stacked, and then discharged. In a case where “only folding” is selected, the plurality of print sheets are discharged in a state in which each print sheet is folded into two and stacked. Note that the popup menu 1803a is not limited to include “none” to “only folding”, but depending on the configuration of the printing apparatus 102, for example, at least one of these options can be omitted or another option can be further included.

The control 1804 is a binding tool-setting section for setting whether or not to use a binding tool, such as a stapler, when a plurality of print sheets are bound, and a binding position when a plurality of print sheets are bound without using a binding tool. By pressing the control 1804, a popup menu 1804a appearing in FIG. 18E is developed and displayed on the control 1804. The popup menu 1804a includes options of “none”, “needle-less binding at upper left”, “needle-less binding at lower left”, “needle-less binding at upper right”, and “needle-less binding at lower right”. This corresponds to the table 1701 (see FIG. 17). In a case where “none” is selected, the plurality of print sheets are simply stacked and then discharged. In a case where “needle-less binding at upper left” is selected, the plurality of print sheets are stapled in an upper left part in a state in which the print sheets are stacked, and then discharged. In a case where “needle-less binding at lower left” is selected, the plurality of print sheets are stapled in a lower left part in a state in which the print sheets are stacked, and then discharged. In a case where “needle-less binding at upper right” is selected, the plurality of print sheets are stapled in an upper right part in a state in which the print sheets are stacked, and then discharged. In a case where “needle-less binding at lower right” is selected, the plurality of print sheets are stapled in a lower right part in a state in which the print sheets are stacked, and then discharged. Note that the popup menu 1804a is not limited to include “none” to “needle-less lower right”, but depending on the configuration of the printing apparatus 102, for example, at least one of these options can be omitted or another option can be further included.

When print data is transmitted from the general-purpose print software 202 to the printing apparatus 102, print setting instruction information (command) for instructing the print setting is added. The print setting instruction information on the functions included in the general-purpose print software 202 is generated by the general-purpose print software 202. On the other hand, the print setting instruction information on the functions not included in the general-purpose print software 202 is generated by the extension application 204. As described above, in the step S817 (see FIG. 8), the intermediate data-editing unit 207 of the extension application 204 generates print data. Further, when this print data is generated, whether or not to add the print setting instruction information is determined. As a result of this determination, it is determined that the print setting instruction information is to be added, the print setting instruction information generated by the general-purpose print software 202 and the print setting instruction information generated by the extension application 204 are added to the print data. Note that the print setting instruction information generated by the extension application 204 in this step is based on the information related to the binding setting received on the detailed setting screen 1800.

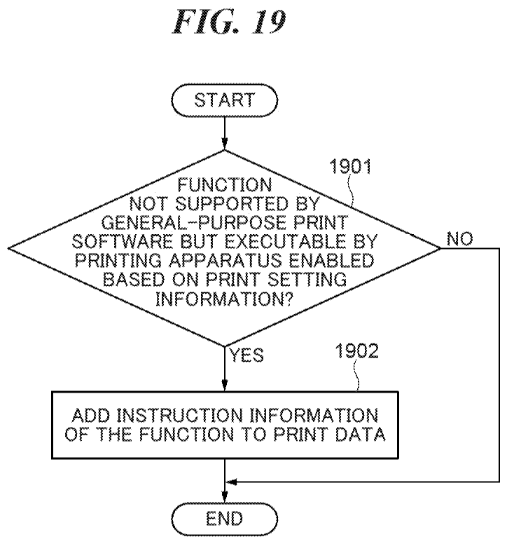

FIG. 19 is a flowchart of a process (process for adding the print setting instruction information to print data) performed by the intermediate data-editing unit 207. As shown in FIG. 19, in a step S1901, the intermediate data-editing unit 207 determines, based on the print setting information (PT), whether or not a function which is not supported by the general-purpose print software 202 and at the same time can be executed by the printing apparatus 102 is set enabled. If it is determined in the step S1901 that a function which is not supported by the general-purpose print software 202 and at the same time can be executed by the printing apparatus 102 is set enabled, the process proceeds to a step S1902. On the other hand, if it is determined in the step S1901 that one of the condition that the function is not supported by the general-purpose print software 202 and the condition that the function which can be executed by the printing apparatus 102 is set enabled is not satisfied, the process is terminated.

In the step S1902, the intermediate data-editing unit 207 adds the print setting instruction information to the print data. This print setting instruction information includes execution instruction information of the bookbinding function in a case where the bookbinding function is enabled in the printing apparatus 102, and includes execution instruction information of needle-less binding in a case where needle-less binding is enabled in the printing apparatus 102. Thus, to the print data, the information related to the binding setting received on the detailed setting screen 1800 is added as the print setting instruction information. Then, the print data to which the print setting instruction information has been added is transmitted to the printing apparatus 102. The printing apparatus 102 can bind the plurality of print sheets, which have been printed, according to the print setting instruction information added to the print data.

As described above, in the present embodiment, even in a case where the general-purpose print software 202 is used, it is possible to cause the printing apparatus 102 to execute the bookbinding function and the needle-less binding function in the printing apparatus 102, which cannot be instructed (executed) by the general-purpose print software 202.

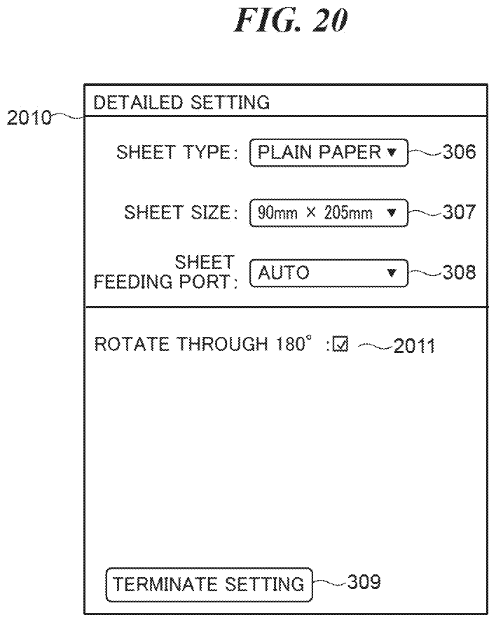

A seventh embodiment will be described below with reference to FIG. 20. The following description will be given mainly of different points from the above-described embodiments, and description of the same points is omitted. In the present embodiment, the general-purpose print software 202 cannot receive a print setting for rotating, when an image is printed by the printing apparatus 102, the image through 180 degrees and printing the image (hereinafter referred to as the “180-degree rotation print setting”). In this 180-degree rotation print setting, processing for rotating each page of intermediate print data through 180 degrees is executed. On the other hand, by causing the CPU 111 to execute steps (control method), described hereinafter, the extension application 204 can receive the 180-degree rotation print setting which cannot be received by the general-purpose print software 202. Note that the information related to the 180-degree rotation print setting is added to the print function information 203 by the print function-extending unit 206 regardless of whether or not the 180-degree rotation printing can be executed by the printing apparatus 102.

For example, in a case where the type of the print sheet on which an image is to be printed by the printing apparatus 102 is an envelope (envelope sheet), it is necessary to feed the envelope in a specific direction. On the other hand, in a case where the envelope is not fed in the specific direction, the orientation of the envelope and the orientation of the image do not coincide with each other, and as a result, there is a fear that the image is not printed on the envelope in a desired state. Further, in a case where the envelope is fed in the specific direction, data of an image to be printed by the printing apparatus 102 is sequentially transmitted to the printing apparatus 102 from the top of the first page of this data, in fragments, and hence printing is started sequentially from the top of the first page. With this, the image is printed in a direction opposite to the sheet discharge direction of the printing apparatus 102. Therefore, in a case where it is necessary to cause the orientation of the image to coincide with the sheet feeding direction, the image is rotated through 180 degrees.

FIG. 20 is a diagram showing an example of a screen displayed on the display section of the printing system according to the seventh embodiment. A detailed setting screen (setting reception screen) 2010 shown in FIG. 20 is a screen for receiving the 180-degree rotation print setting. This detailed setting screen 2010 is displayed on the display section 119 by the print setting screen-extending unit 205 in a case where the information related to the 180-degree rotation print setting has been added to the print function information 203. The detailed setting screen 2010 includes the controls 306 to 309. Further, the detailed setting screen 2010 additionally includes a control 2011.

The control 2011 is a switching section for switching whether to enable or disable the 180-degree rotation print setting. In a state in which a checkbox included in the control 2011 is checked, the 180-degree rotation print setting is set enabled. Note that in a state in which the checkbox included in the control 2011 is unchecked, the 180-degree rotation print setting is set disabled. As described above, with the control 306, the user can select and set a type of sheets used for printing performed by the printing apparatus 102. In the present embodiment, the control 306 in the state in which the checkbox of the control 2011 is checked functions as a type setting section for setting a type of print sheets to be printed by the printing apparatus 102 in a state in which the image is rotated through 180 degrees. In FIG. 20, “envelope” is selected by the control 306 by way of example. Further, with the control 307, the user can select and set a size of sheets used for printing performed by the printing apparatus 102. In the present embodiment, the control 307 in the state in which the checkbox of the control 2011 is checked functions as a size setting section for setting a size of print sheets to be printed by the printing apparatus 102 in a state in which the image is rotated through 180 degrees. In FIG. 20, “90× 205 mm” is selected by the control 307 by way of example. The above-described information related to the 180-degree rotation print setting received on the detailed setting screen 2010 is transmitted to the printing apparatus 102. Then, the printing apparatus 102 can rotate the image through 180 degrees and print the image based on this information related to the 180-degree rotation print setting.

Further, the print setting screen-extending unit 205 is configured to be capable of switching whether to enable or disable the 180-degree rotation print setting according to selection states on the control 306 and the control 307 depending on e.g. a type of the printing apparatus 102. In the present embodiment, a case where the support PDL is PWG-Raster, as the characteristics of the printing apparatus 102 which enables the 180-degree rotation print setting, is described by way of example. Then, in a case where “envelope” is selected by the control 306, and at the same time “90×205 mm” is selected by the control 307, the checkbox of the control 2011 is changed to the enabled state. Note that this enabled state can be fixed or can be changed to the disabled state by a user's operation. Further, in a case where “envelope” is not selected by the control 306, and at the same time “90× 205 mm” is not selected by the control 307, the checkbox of the control 2011 can be returned to the initial state, i.e., a state before being checked, or can be held in the enabled state. With this configuration of switching whether to enable or disable the 180-degree rotation print setting according to e.g. a type of the printing apparatus 102, it is possible to cause the orientation of the image to coincide with the sheet feeding direction, and therefore, a desired print result can be obtained.

As described above, in the present embodiment, even in a case where the general-purpose print software 202 is used, it is possible to cause the printing apparatus 102 to execute the 180-degree rotation print setting, which cannot be executed by the general-purpose print software 202. Incidentally, some printing apparatus 102 is incapable of executing image processing for rotating an image included in print data through 180 degrees. In this case, even when the extension application 204 generates print data including information of the 180-degree rotation print setting, it is impossible to cause the printing apparatus 102 to execute 180-degree rotation printing. To cope with this, it is preferable to process printing similarly to the second embodiment. Specifically, in a case where the printing apparatus 102 cannot execute image processing for rotating an image through 180 degrees, the extension application 204 generates print data in which the image has been rotated through 180 degrees according to the 180-degree rotation print setting received on the detailed setting screen 2010. Then, this print data is transmitted to the printing apparatus 102. With this, a desired print result in which the image has been rotated through 180 degrees can be obtained.

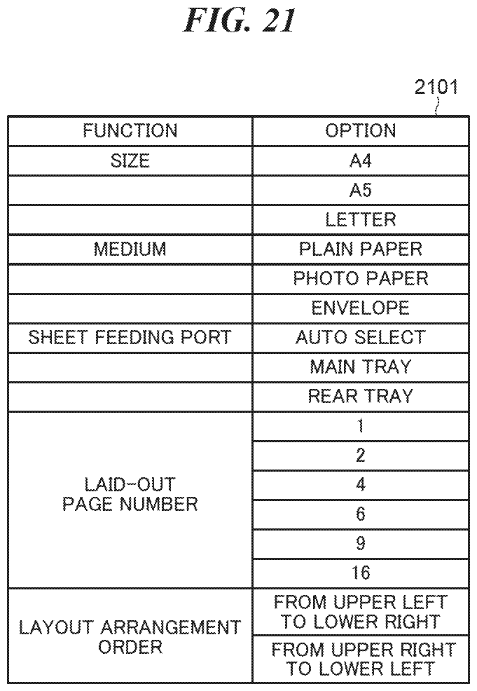

An eighth embodiment will be described below with reference to FIGS. 21 to 26, but the description will be given mainly of different points from the above-described embodiments, and description of the same points is omitted. In the present embodiment, the general-purpose print software 202 cannot receive, when printing is performed on a print sheet by the printing apparatus 102, a layout setting for laying out (allocating) a predetermined number of pages per one side of the print sheet. On the other hand, the extension application 204 can receive the layout setting which cannot be received by the general-purpose print software 202 by causing the CPU 111 to execute steps (control method), described hereinafter. Examples of the layout setting (N-in-1 (“N” is a positive integer) setting) include a “1-in-1” setting for laying out one page per one side of a print sheet, and a “2-in-1” setting for laying out two pages per one side of a print sheet. Further, in addition to the above, for example, a “4-in-1” setting for laying out four pages per one side of a print sheet, and a “6-in-1” setting for laying out six pages per one side of a print sheet are included. Further, a “9-in-1” setting for laying out nine pages per one side of a print sheet, and a “16-in-1” setting for laying out 16 pages per one side of a print sheet are also included.

FIG. 21 is a diagram showing an example of a list of the capabilities information of the printing apparatus according to the eighth embodiment. A table 2101 shown in FIG. 21 shows a list of the capabilities information of the printing apparatus 102. The capabilities information includes the information related to sizes of sheets (print sheets), the information related to types of sheets (media), and the information related to sheet feeding ports, similar to the first embodiment (see FIG. 5). Further, in the present embodiment, as the other capabilities information, information related to the number of pages to be laid out per one side of a print sheet (laid-out page number), and information related to a direction of arranging pages laid out per one side of a print sheet (layout arrangement order) are included. Note that the capabilities information of the general-purpose print software 202 in the present embodiment includes the information related to sheet sizes, the information related to sheet types, and the information related to sheet feeding ports but does not include information related to laid-out page numbers and information related to layout arrangement orders. Further, information related to layout settings is added to the print function information 203 by the print function-extending unit 206 regardless of whether or not the layout can be executed by the printing apparatus 102.

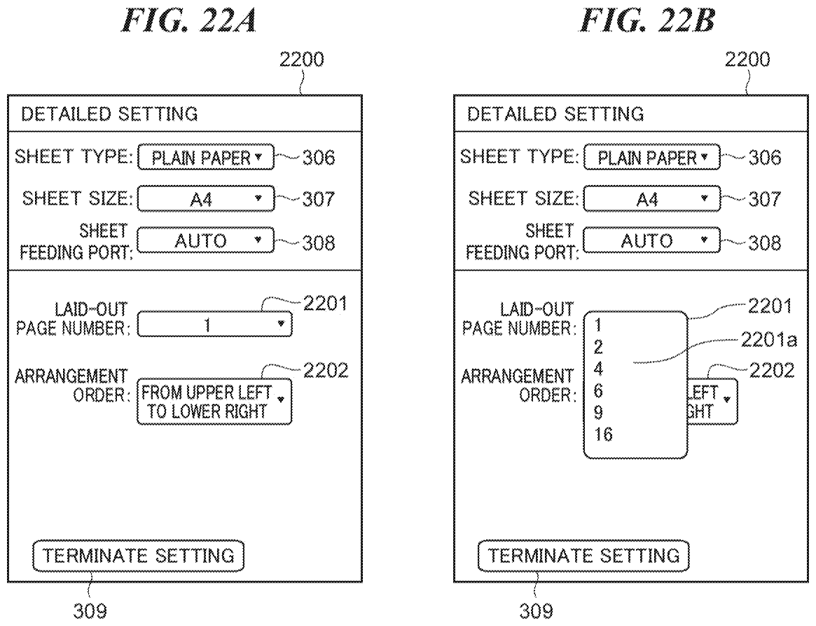

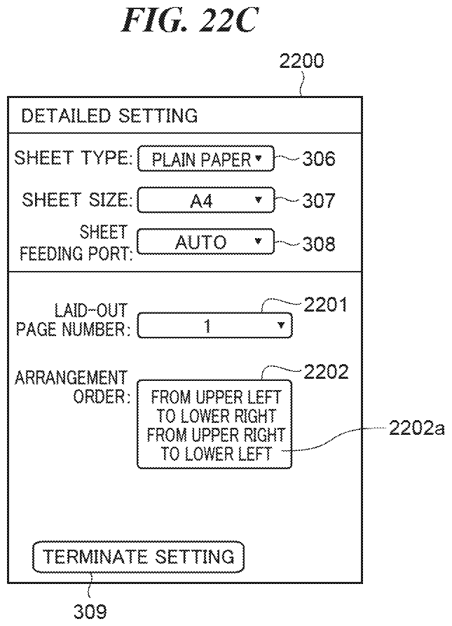

FIGS. 22A to 22C are diagrams each showing an example of a screen displayed on the display section of the printing system. A detailed setting screen (setting reception screen) 2200 shown in FIGS. 22A to 22C is a screen for receiving a layout setting. This detailed setting screen 2200 is displayed on the display section 119 by the print setting screen-extending unit 205. The detailed setting screen 2200 shown in FIG. 22A is a screen in an initial state. This detailed setting screen 2200 includes the controls 306 to 309. Further, the detailed setting screen 2200 additionally includes a control 2201 and a control 2202.

The control 2201 is a page number-setting section for setting the number of pages to be laid out. By pressing the control 2201, a popup menu 2201a appearing in FIG. 22B is developed and displayed on the control 2201. The popup menu 2201a includes options of “1”, “2”, “4”, “6”, “9”, and “16”. This corresponds to the table 2101 (see FIG. 21). For example, in a case where “2” is selected, two pages are laid out per one side of a print sheet. Further, in a case where “4” is selected, four pages are laid out per one side of a print sheet. Thus, with the control 2201, the user can set the layout setting (N-in-1 setting) according to each option. Note that the popup menu 2201a is not limited to include “2” to “16”, and depending on the configuration of the printing apparatus 102, for example, at least one of these options (settings) can be omitted, or another option or other options can be included.

The control 2202 is an arrangement order-setting section for setting the layout arrangement order (direction setting section). By pressing the control 2202, a popup menu 2202a appearing in FIG. 22C is developed and displayed on the control 2202. The popup menu 2202a includes options of “from upper left to lower right” and “from upper right to lower left”. This corresponds to the table 2101 (see FIG. 21). For example, in a case where “4” is selected by the control 2201, and “from upper left to lower right” is selected by the control 2202, four pages from the first page to the fourth page are sequentially arranged from the upper left to the lower right. Further, in a case where “4” is selected by the control 2201, and “from upper right to lower left” is selected by the control 2202, the four pages from the first page to the fourth page are sequentially arranged from the upper right to the lower left. Note that the popup menu 2202a is not limited to include “from upper left to lower right” and “from upper right to lower left”, and depending on the configuration of the printing apparatus 102, at least one of these options can be omitted, or another option can be added.

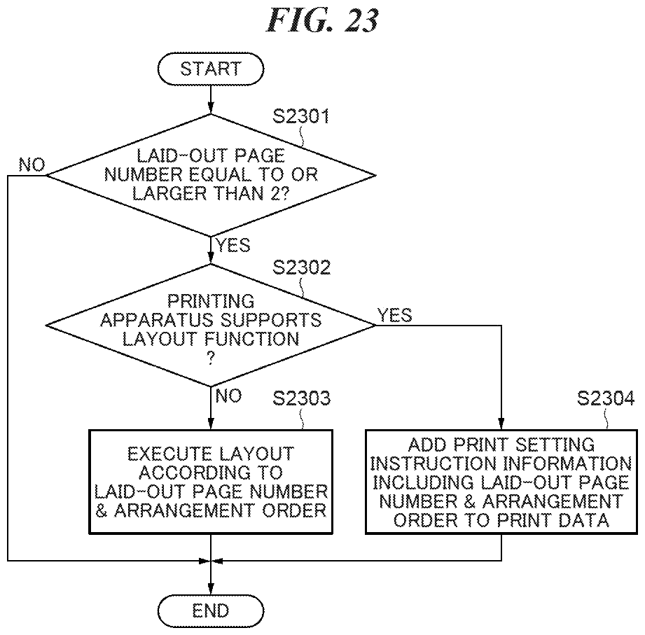

FIG. 23 is a flowchart of a process (layout process) performed by the intermediate data-editing unit 207. As shown in FIG. 23, in a step S2301, the intermediate data-editing unit 207 determines whether or not the option selected by the control 2201 on the detailed setting screen 2200 is equal to or larger than “2”. If it is determined in the step S2301 that the option is equal to or larger than “2”, the process proceeds to a step S2302. On the other hand, if it is determined in the step S2301 that the option is not equal to or larger than “2”, i.e., the option is “1”, the process is terminated.

In the step S2302, the intermediate data-editing unit 207 determines whether or not the layout function can be executed according to the option selected by the control 2201 on the detailed setting screen 2200. If it is determined in the step S2302 that the layout function can be executed, the process proceeds to a step S2304. On the other hand, if it is determined in the step S2302 that the layout function cannot be executed, the process proceeds to a step S2303.

In the step S2303, the intermediate data-editing unit 207 generates print data based on the option (layout setting) selected by the control 2201 on the detailed setting screen 2200. For example, in a case where “4” is selected by the control 2201, and “from upper left to lower right” is selected by the control 2202, the print data is generated as follows: The print data is generated as data in which the four pages from the first page to the fourth pages are sequentially arranged from the upper left to the lower right per one side of the print sheet Then, this print data is transmitted to the printing apparatus 102. With this, a desired print result in which the four pages from the first page to the fourth pages are sequentially arranged from the upper left toward the lower right per one side of the print sheet is obtained.

In the step S2304, the intermediate data-editing unit 207 adds the print setting instruction information including the information related to the option selected by the control 2201 and the option selected by the control 2202 on the detailed setting screen 2200 to the print data. Then, this print data is transmitted to the printing apparatus 102. With this, the printing apparatus 102 edits the print data based on the print setting instruction information. For example, in a case where “4” is selected by the control 2201, and “from upper left to lower right” is selected by the control 2202, the print data is edited such that the four pages from the first page to the fourth pages are sequentially arranged from the upper left to the lower right per one side of the print sheet. With this, a desired print result in which the four pages from the first page to the fourth pages are sequentially arranged from the upper left to the lower right per one side of the print sheet is obtained.

As described above, in the present embodiment, even in a case where the general-purpose print software 202 is used, it is possible to cause the printing apparatus 102 to execute the layout function, which cannot be executed by the general-purpose print software 202.

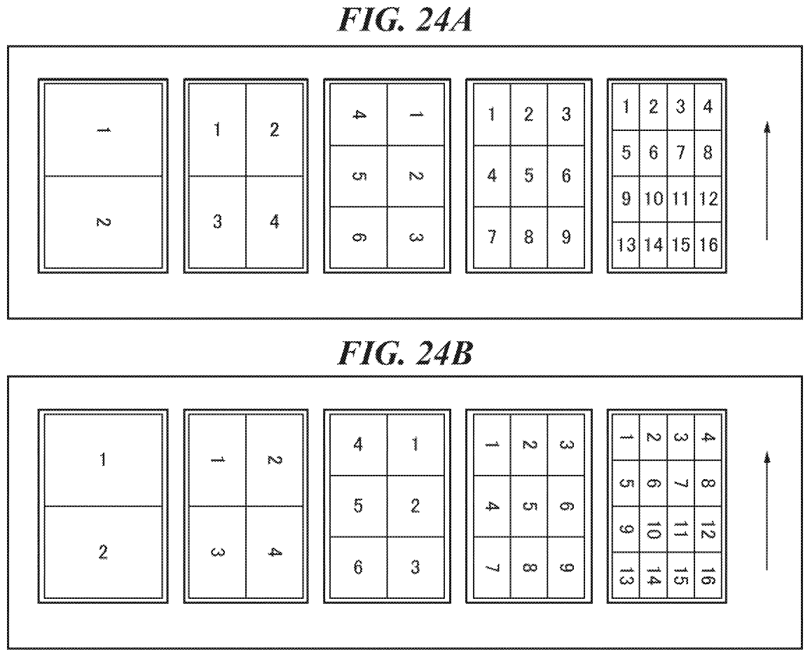

The layout process is realized by executing image processing, such as reduction, rotation, and moving processing, on the print data generated by using the drawing application 201, according to conditions, such as the sheet size and the direction of printing. Therefore, a print result (output result) is different depending on a combination of an aspect ratio of a print sheet, a printing direction, and the number of pages to be laid out. FIGS. 24A and 24B are diagrams each showing an example of the layout of pages in a case where the layout process is performed by the intermediate data-editing unit. FIG. 24A is a diagram showing an example of the layout in a case where the sheet size is set to “A4” and the printing direction is set to “vertical”. FIG. 24B is a diagram showing an example of the layout in a case where the sheet size is set to “A4” and the printing direction is set to “horizontal”. Note that arrows illustrated in FIGS. 24A and 24B each indicate a direction of conveying a print sheet.

To lay out a plurality of pages on one side of a print sheet, first, for example, in a case where the printing direction is set to “horizontal”, the print sheet (sheet size) is regarded as a target sheet by rotating the same through 90 degrees. Then, a printing area of the targe sheet is divided according to one of “2-up”, “4-up”, “6-up”, and “16-up”. The 2-up refers to an operation of dividing a longer one of a vertical side and a horizontal side of the printing area into two. The 4-up refers to an operation of dividing the vertical side and the horizontal side of the printing area into two, respectively. The 6-up refers to an operation of dividing a longer one of the vertical side and the horizontal side of the printing area into three and a shorter one of the same into two. The 9-up refers to an operation of dividing the vertical side and the horizontal side of the printing area into three, respectively. The 16-up refers to an operation of dividing the vertical side and the horizontal side of the printing area into four, respectively. Then, the aspect ratio of each divided area and the aspect ratio of the printing area of the original target sheet are compared. Then, in a case where both of the divided area and the printing area are vertically long or horizontally long, the printing direction is not changed, and the pages are laid out in the divided areas, respectively. Further, in a case where the divided area and the printing area are different in the aspect ratio, the pages are laid out in the divided areas in a state in which the printing direction is reversed.

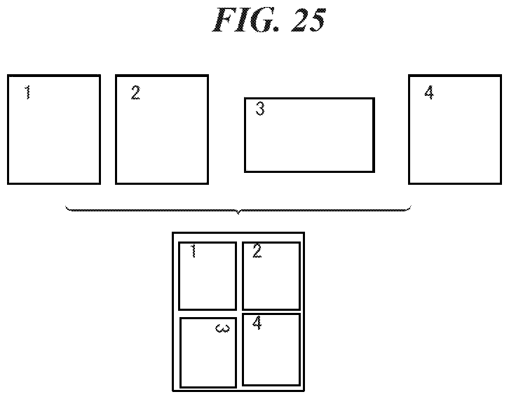

In a case where the sheet size is changed by the drawing application 201 in the middle of the document, combined data is generated such that each page is arranged in a state enlarged or reduced so as to be printed as large as possible in an area in which this page has been laid out. Further, in a case where the orientation of a page is changed by the drawing application 201 in the middle of the document, a page different in orientation from the first page is rotated and arranged so as to be printed as large as possible in an area in which this page has been laid out. Further, the rotation is performed to make the upper left of each page oriented in the sheet conveying direction. FIG. 25 is a diagram showing an example of a print result obtained in a case where the layout process is performed by the intermediate data-editing unit. FIG. 25 shows a print result obtained in a case where the intermediate data-editing unit 207 has laid out the intermediate data of four pages each having a sheet size of “A4” and set to a printing direction of “horizontal”, according to the setting of the laid-out page number of 4. As shown in FIG. 25, the third page is rotated through 90 degrees so as to be printed at the largest size in the area.

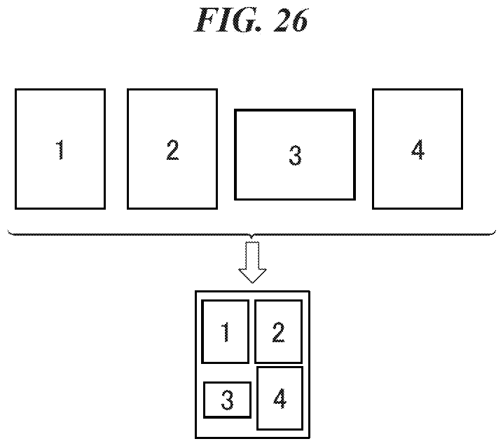

In a case where the sheet size is changed by the drawing application 201 in the middle of the document, each page is arranged in a state enlarged or reduced so as to be printed as large as possible in an area in which this page has been laid out. Further, in a case where the orientation of a page is changed by the drawing application 201 in the middle of the document, the printing direction of a page different in orientation from the first page is held in the area in which this page has been laid out. Further, in a state in which the printing direction is held, the page is arranged in a state enlarged or reduced so as to be accommodated in the area. FIG. 26 is a diagram showing an example of a print result obtained in a case where the layout process is performed by the printing apparatus. FIG. 26 shows a print result obtained in a case where the printing apparatus 102 has laid out the intermediate data of four pages, which has the sheet size set to “A4” and the printing direction set to “horizontal”, according to the setting of the laid-out page number, set to 4. As shown in FIG. 26, the third page is printed in the area in a state holding the printing direction.

As described above, whether or not the layout function is executed by the intermediate data-editing unit 207 is switched according to whether or not the layout function can be executed by the printing apparatus 102.

According to the present disclosure, even in a case where a general-purpose program is used, it is possible to cause a printing apparatus to execute a function which cannot be executed by the general-purpose program.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-070827, filed Apr. 22, 2025, which is hereby incorporated by reference herein in its entirety.

What is claimed is:

1. A non-transitory computer-readable storage medium storing an application program, the application program causing a computer to execute a control method,
the control method comprising:
supporting a general-purpose program operating according to the Internet Printing Protocol;
displaying a setting reception screen for receiving a print setting for printing an image to be printed, after rotating the image through 180 degrees;
generating print data in which the image is rotated through 180 degrees by the print setting received on the setting reception screen; and
transmitting the print data to a printing apparatus.

2. The non-transitory computer-readable storage medium according to claim 1, wherein the setting reception screen includes a switching section for switching whether to enable or disable the print setting.

3. The non-transitory computer-readable storage medium according to claim 1, wherein the setting reception screen includes a type setting section for setting a type of a printing medium on which the image is to be printed.

4. The non-transitory computer-readable storage medium according to claim 1, wherein the setting reception screen includes a size setting section for setting a size of a printing medium on which the image is to be printed.

5. The non-transitory computer-readable storage medium according to claim 1, wherein the general-purpose program is a program incapable of receiving the print setting.

6. A method of performing control to support a general-purpose program operating according to the Internet Printing Protocol, comprising:
displaying a setting reception screen for receiving a print setting for printing an image to be printed, after rotating the image through 180 degrees;
generating print data in which the image is rotated through 180 degrees by the print setting received on the setting reception screen; and
transmitting the print data to a printing apparatus.

7. An information processing apparatus including a general-purpose program operating according to the Internet Printing Protocol and an application program supporting the general-purpose program,
wherein the application program causes a computer of the information processing apparatus to:
display a setting reception screen for receiving a print setting for printing an image to be printed, after rotating the image through 180 degrees;
generate print data in which the image is rotated through 180 degrees by the print setting received on the setting reception screen; and
transmit the print data to a printing apparatus.
